(19) United States
(12) Patent Application Publication
(10) Pub. No.: US 2019/0057101 A1
(43) Pub. Date: Feb. 21, 2019

(54) EFFICIENT DELETION OF ARCHIVE RECORDS AFTER EXPIRATION OF A TENANT-DEFINED RETENTION PERIOD

(71) Applicant: salesforce.com, inc., San Francisco, CA (US)

(72) Inventors: BRIAN D. ESSERLIEU, WALNUT CREEK, CA (US); SAMARPAN JAIN, FREMONT, CA (US); JAN ASITA FERNANDO, SAN FRANCISCO, CA (US); JAMES FERGUSON, SAN FRANCISCO, CA (US); CODY MARCEL, DENVER, CO (US)

(73) Assignee: salesforce.com, inc., San Francisco, CA (US)

(21) Appl. No.: 15/681,648

(22) Filed: Aug. 21, 2017

(51) Int. Cl. G06F 17/30; G06F 3/06

(52) U.S. Cl. CPC G06F 17/30085; G06F 3/0604; G06F 17/30368

(57) ABSTRACT

Methods and systems are provided for deleting archive records from a distributed archive database system (DADS). A deletion job scheduler (DJS) can run deletion jobs on a regular basis. For example, the DJS can run a deletion job for archive records of a tenant that have a particular object type. The DJS can dynamically determine a deletion window that includes archive records within the DADS that are potentially eligible for deletion, and calculate an oldest allowable archive timestamp value based on a tenant-defined archive retention period for that tenant for that object type. The DJS can then query the DADS using index keys to retrieve archive records that are within the deletion window and belong to the tenant such that they are ordered from oldest to newest based on their respective created dates. The DJS can then identify which of those archive records have expired, and mark them for deletion.

### TECHNICAL FIELD

Embodiments of the subject matter described herein relate generally to cloud-based computing. More particularly, embodiments of the subject matter relate to a system and method for efficient deletion of archive records after expiration of a tenant-defined retention period.

BACKGROUND

Salesforce.com provides a Shield product offering that helps organizations/tenants with their data compliance and control requirements. For example, the Shield product helps organizations who have complex governance and compliance needs, and lets organizations see who is doing what with sensitive data, know the state and value of their data going back up to ten years, and encrypt sensitive data, while still preserving business functionality. One of the key services provided by Shield includes is tracking and retaining logs on who and how data is accessed. Field history tracking allows an organization to capture when the values within specified fields change when an instance of an object is edited.

Salesforce's Field Audit Trail (FAT) feature that allows customers to retain an archive of the changes they have made to their data for audit/compliance purposes. This feature helps tenants comply with industry regulations related to audit capability and data retention. FAT can help ensure that audit data remains serviceable throughout its lifetime. FAT is built on a big data back end enabling massive scalability and letting customers access audit data in an efficient manner. FAT gives organizations the ability go back in time and see the state and value of their data on any date, at any time. FAT expands what is currently available with Field History Retention, giving customers up to ten years of audit trail data for up to 60 fields per object. Among other features, FAT lets tenants define a policy to retain archived field history data up to ten years, independent of field history tracking. After a tenant defines their FAT policy and deploys it, production data is migrated from related history lists into the FieldHistoryArchive object. The first copy writes the field history that's defined by the tenant's policy to archive storage. Subsequent copies transfer only the changes since the last copy.

### BRIEF DESCRIPTION OF THE DRAWINGS

A more complete understanding of the subject matter may be derived by referring to the detailed description and claims when considered in conjunction with the following figures, wherein like reference numbers refer to similar elements throughout the figures.

FIG. 1 is a schematic block diagram of an example of a multi-tenant computing environment in which features of the disclosed embodiments can be implemented in accordance with some of the disclosed embodiments.

FIG. 2 is a block diagram that illustrates components of a multitenant archive system that is used to archive changes to instances of objects from a multi-tenant database system at a distributed archive database system in accordance with the disclosed embodiments.

FIG. 3A is a block diagram that illustrates components of an archive system that are used to archive changes to instances of objects from a multi-tenant database system at a distributed archive database system in accordance with the disclosed embodiments.

FIG. 3B is a flow diagram that illustrates archival operations within a partitioned tenant space in accordance with the disclosed embodiments.

FIG. 4 is a flowchart that illustrates an exemplary method for deleting archive records from a distributed archive database system in accordance with the disclosed embodiments.

FIG. 5 illustrates the concept of a deletion window in accordance with the disclosed embodiments.

FIG. 6 is a flowchart that illustrates an exemplary method for deleting archive records from the distributed archive database system in accordance with the disclosed embodiments.

FIG. 7 is a flowchart that illustrates an exemplary method for evaluating archive records in a limit bounded page to determine whether those archive records have expired and should be deleted in accordance with in accordance with the disclosed embodiments.

FIG. 8 shows a block diagram of an example of an environment in which an on-demand database service can be used in accordance with some implementations.

FIG. 9 shows a block diagram of example implementations of elements of FIG. 8 and example interconnections between these elements according to some implementations.

FIG. 10A shows a system diagram illustrating example architectural components of an on-demand database service environment according to some implementations.

FIG. 10B shows a system diagram further illustrating example architectural components of an on-demand database service environment according to some implementations.

FIG. 11 illustrates a diagrammatic representation of a machine in the exemplary form of a computer system within which a set of instructions, for causing the machine to perform any one or more of the methodologies discussed herein, may be executed.

### DETAILED DESCRIPTION

In large-scale, multi-tenant database systems, the management of huge volumes of data that must be retained over time presents a significant technical challenge. While providing each tenant with the ability to define their own unique retention policies is a promising feature, one challenge lies in maintaining an enormous database while ensuring that archive records are deleted, as appropriate and on time, when having many different tenants that each define their own unique retention policies. This problem has not yet been addressed.

An important component in audit compliance is the ability to delete archive records after they've been maintained for a duration defined by the compliance guidelines governing the data retention. It would be desirable to provide systems, methods, procedures, and technologies that can allow tenants to retain the data from the day of archive, and delete the data once it expired. It would be desirable to provide a system that allows tenants to set their own policies for retention of their data, and while also allowing for deletion of the data once the archive duration of the archived data exceeds the retention policy defined by the tenant. It would be desirable if such a system can delete data for each of a tenant's different data types based on each tenant's defined retention policy, but also allow for this to happen for all tenants simultaneously (in parallel).

To address the issues discussed above, systems, methods, procedures, and technology are provided for a multi-tenant archive system for storing archive records for a plurality of tenants. Each object has a particular object type of a plurality of different object types. Each instance of an object (also referred to as a “record”) can be modified (e.g., a field of that instance of the object can be changed). The multi-tenant archive tracks these modification/changes, and archives them each as an archive record. The multi-tenant archive system includes a multi-tenant database system and a distributed archive database system. Each tenant defines their own archive retention policy for each object type. Each archive retention policy includes a tenant-defined storage period and a tenant-defined archive retention period. The tenant-defined storage period specifies, for each object type, how long changes to instances of objects of that particular object type are to be stored at the multi-tenant database system before being archived. The tenant-defined archive retention period specifies, for each object type, how long archive records of that particular object type are to be archived before being deleted from the distributed archive database system. In other words, each tenant can define multiple unique archive retention periods (e.g., one for each object type). Further, even for the same object type, each tenant can have their own unique archive retention period such that the retention periods for that object type can vary among tenants (e.g., different retention periods for the same object type for each tenant).

The multi-tenant database system store changes to instances of objects for the plurality of tenants for the tenant-defined storage period for each object type (as specified by the tenant for that object type. The distributed archive database system archives the changes to the instances of objects for the plurality of tenants as archive records. The archive records for each tenant are archived within the distributed archive database system when the tenant-defined storage period for that object type expires until the tenant-defined archive retention period for that object type expires

Each tenant onboards changes to instances of objects to a multi-tenant archive system at different points in time, and can archive them at different points in time. The changes to instances of objects for each tenant are archived based on when they onboard, and retained for a length of time defined by the tenant (i.e., a tenant-defined archive retention period that indicates an amount of time that each archive record is to be retained for). The multi-tenant archive system includes a multi-tenant deletion framework that allows for efficient deletion of archive records after expiration of the tenant-defined archive retention period. The multi-tenant deletion framework can allow archive records to be deleted from a non-relational, distributed database (e.g., HBase) after a tenant-defined retention archive period has been exceeded. The correct deletion time for each tenant can vary based on when the tenant first onboards a particular change to an instance of an object to the distributed archive database system as an archive record, and the tenant-defined archive retention period for that archive record per its object type.

In accordance with the disclosed embodiments, a deletion job processor (or scheduler) is configured to run deletion jobs (or cron jobs) on a regular basis. The deletion job scheduler can periodically run a deletion job for each tenant to determine which archive records of a particular object type have expired, per a unique, tenant-defined archive retention period, and can then remove/delete/purge those expired records from the archive. The disclosed embodiments can accomplish this without needing to do a full table scan of all data that is archived, but only considering the archive records for that tenant that fall within a deletion window (e.g., that are potentially eligible for deletion). The disclosed embodiments can allow for this deletion of expired records even though each tenant can define their own unique archive retention period for each object type, and even though each tenant can onboard changes to instances of objects to the system at different times.

For example, the deletion job scheduler can run a deletion job for archive records of a tenant that have a particular object type. In doing so, the deletion job scheduler can dynamically determine a deletion window of archive records within another table at the distributed archive database system that are potentially eligible for deletion from the distributed archive database system. For example, the deletion window includes only the archive records have created dates that are in a range greater than or equal to a minimum lower boundary date (T1) and less than a maximum upper boundary date (T-END) so that only the archive records that are potentially eligible for deletion from the distributed archive database system are queried. As such, if a tenant could not have archive records older than their archive retention policy, it is unnecessary to search through those records, which can help us reduce the compute resources needed to perform a deletion job.

The deletion job scheduler can then calculate an oldest allowable archive timestamp value. The oldest allowable archive timestamp value defines a point in time (e.g., date and time) where any archive record that has an archive timestamp less than the oldest allowable archive timestamp value will be considered to be expired and ready for deletion. In one embodiment, the oldest allowable archive timestamp value is equal to a difference between a current date and time when the deletion job runs and the archive retention period for that tenant for that object type.

The deletion job scheduler can then query the distributed archive database system using index keys to retrieve archive records that are within the deletion window and belong to the tenant such that the archive records that belong to the tenant are ordered from oldest to newest based on their respective created dates when each archive record was created. For example, in one embodiment, each index key can be arranged according to a query pattern that includes a tenant identifier field that specifies the tenant, a parent key prefix field that specifies the object type, and a created date field that indicates the date and time on which an instance of an object was modified and the archive record was created. The query pattern of each index key is arranged to find the oldest archive records in the deletion window sorted by created date in descending order down to the newest archive records in the deletion window so that archive records that are more likely to be expired are found first.

The deletion job scheduler can then identify which of the archive records, that are within the deletion window and belong to the tenant, have expired. For example, each archive record that has an archive timestamp value that is less than the oldest allowable archive timestamp value can be identified as being expired. In one embodiment, the deletion job scheduler can define page limits within the deletion window and divide the deletion window into a set of limit bounded pages. Each limit bounded page includes a batch of archive records for a particular tenant of a particular object type. When the deletion job scheduler selects a limit bounded page that includes archive records for the tenant for deletion processing, the deletion job scheduler can evaluate each archive record within the limit bounded page to determine whether an archive timestamp value of that archive record is less than the oldest allowable archive timestamp value. The archive timestamp value for each archive record indicates a date and time when a change occurred to a corresponding object that reflects when that archive record should have been archived. Each archive record that has an archive timestamp value that is less than the oldest allowable archive timestamp value is marked can be identified as being expired.

The deletion job scheduler can then mark those expired records for deletion, and schedule their deletion via a message queue. For example, the deletion job processor can chunk the expired records that are to be deleted into groups (e.g., grouped by tenant), and enqueue the groups of expired records in the message queue for deletion. The message queue can then dequeue and delete the groups of expired records.

In the examples that follow, the multi-tenant deletion framework will be described in the context of a cloud-based system. Although the embodiments described herein can be implemented in the context of any cloud-based computing environment including, for example, a multi-tenant database system, it should be appreciated that this environment is non-limiting and that the disclosed embodiments can also be applied in the context of other systems.

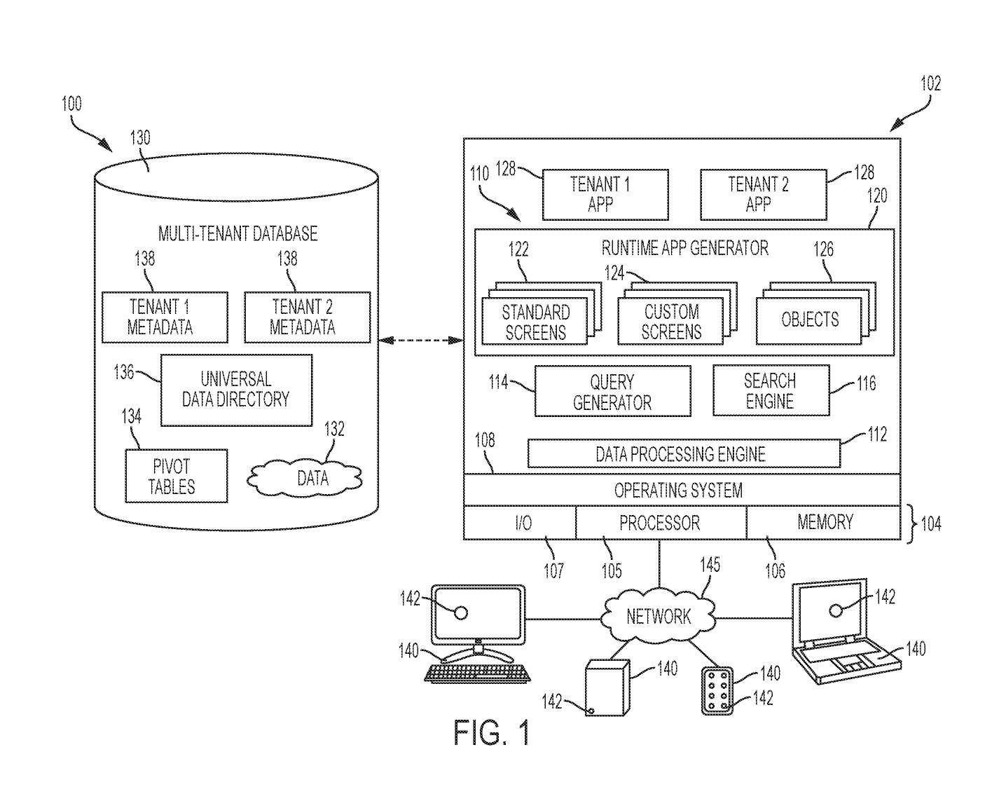

FIG. 1 is a schematic block diagram of an example of a multi-tenant computing environment in which features of the disclosed embodiments can be implemented in accordance with the disclosed embodiments. As shown in FIG. 1, an exemplary cloud-based solution may be implemented in the context of a multi-tenant system 100 including a server 102 that supports applications 128 based upon data 132 from a database 130 that may be shared between multiple tenants, organizations, or enterprises, referred to herein as a multi-tenant database. The multi-tenant system 100 can be shared by many different organizations, and handles the storage of, and access to, different metadata, objects, data and applications across disparate organizations. In one embodiment, the multi-tenant system 100 can be part of a database system, such as a multi-tenant database system.

The multi-tenant system 100 can provide applications and services and store data for any number of organizations. Each organization is a source of metadata and data associated with that metadata that collectively make up an application. In one implementation, the metadata can include customized content of the organization (e.g., customizations done to an instance that define business logic and processes for an organization). Some non-limiting examples of metadata can include, for example, customized content that describes a build and functionality of objects (or tables), tabs, fields (or columns), permissions, classes, pages (e.g., Apex pages), triggers, controllers, sites, communities, workflow rules, automation rules and processes, etc. Data is associated with metadata to create an application. Data can be stored as one or more objects, where each object holds particular records for an organization. As such, data can include records (or user content) that are held by one or more objects.

The multi-tenant system 100 allows users of user systems 140 to establish a communicative connection to the multi-tenant system 100 over a network 145 such as the Internet or any type of network described herein. Based on a user's interaction with a user system 140, the application platform 110 accesses an organization's data (e.g., records held by an object) and metadata that is stored at one or more database systems 130, and provides the user system 140 with access to applications based on that data and metadata. These applications are executed or run in a process space of the application platform 110 will be described in greater detail below. The user system 140 and various other user systems (not illustrated) can interact with the applications provided by the multi-tenant system 100. The multi-tenant system 100 is configured to handle requests for any user associated with any organization that is a tenant of the system. Data and services generated by the various applications 128 are provided via a network 145 to any number of user systems 140, such as desktops, laptops, tablets, smartphones or other client devices, Google Glass™, and any other computing device implemented in an automobile, aircraft, television, or other business or consumer electronic device or system, including web clients.

Each application 128 is suitably generated at run-time (or on-demand) using a common application platform 110 that securely provides access to the data 132 in the database 130 for each of the various tenant organizations subscribing to the system 100. The application platform 110 has access to one or more database systems 130 that store information (e.g., data and metadata) for a number of different organizations including user information, organization information, custom information, etc. The database systems 130 can include a multi-tenant database system 130 as described with reference to FIG. 1, as well as other databases or sources of information that are external to the multi-tenant database system 130 of FIG. 1. In accordance with one non-limiting example, the service cloud 100 is implemented in the form of an on-demand multi-tenant customer relationship management (CRM) system that can support any number of authenticated users for a plurality of tenants.

As used herein, a “tenant” or an “organization” should be understood as referring to a group of one or more users (typically employees) that share access to common subset of the data within the multi-tenant database 130. In this regard, each tenant includes one or more users and/or groups associated with, authorized by, or otherwise belonging to that respective tenant. Stated another way, each respective user within the multi-tenant system 100 is associated with, assigned to, or otherwise belongs to a particular one of the plurality of enterprises supported by the system 100.

Each enterprise tenant may represent a company, corporate department, business or legal organization, and/or any other entities that maintain data for particular sets of users (such as their respective employees or customers) within the multi-tenant system 100. Although multiple tenants may share access to the server 102 and the database 130, the particular data and services provided from the server 102 to each tenant can be securely isolated from those provided to other tenants. The multi-tenant architecture therefore allows different sets of users to share functionality and hardware resources without necessarily sharing any of the data 132 belonging to or otherwise associated with other organizations.

The multi-tenant database 130 may be a repository or other data storage system capable of storing and managing the data 132 associated with any number of tenant organizations. The database 130 may be implemented using conventional database server hardware. In various embodiments, the database 130 shares processing hardware 104 with the server 102. In other embodiments, the database 130 is implemented using separate physical and/or virtual database server hardware that communicates with the server 102 to perform the various functions described herein.

In an exemplary embodiment, the database 130 includes a database management system or other equivalent software capable of determining an optimal query plan for retrieving and providing a particular subset of the data 132 to an instance of application (or virtual application) 128 in response to a query initiated or otherwise provided by an application 128, as described in greater detail below. The multi-tenant database 130 may alternatively be referred to herein as an on-demand database, in that the database 130 provides (or is available to provide) data at run-time to on-demand virtual applications 128 generated by the application platform 110, as described in greater detail below.

In practice, the data 132 may be organized and formatted in any manner to support the application platform 110. In various embodiments, the data 132 is suitably organized into a relatively small number of large data tables to maintain a semi-amorphous “heap”-type format. The data 132 can then be organized as needed for a particular virtual application 128. In various embodiments, conventional data relationships are established using any number of pivot tables 134 that establish indexing, uniqueness, relationships between entities, and/or other aspects of conventional database organization as desired. Further data manipulation and report formatting is generally performed at run-time using a variety of metadata constructs. Metadata within a universal data directory (UDD) 136, for example, can be used to describe any number of forms, reports, workflows, user access privileges, business logic and other constructs that are common to multiple tenants.

Tenant-specific formatting, functions and other constructs may be maintained as tenant-specific metadata 138 for each tenant, as desired. Rather than forcing the data 132 into an inflexible global structure that is common to all tenants and applications, the database 130 is organized to be relatively amorphous, with the pivot tables 134 and the metadata 138 providing additional structure on an as-needed basis. To that end, the application platform 110 suitably uses the pivot tables 134 and/or the metadata 138 to generate “virtual” components of the virtual applications 128 to logically obtain, process, and present the relatively amorphous data 132 from the database 130.

The server 102 may be implemented using one or more actual and/or virtual computing systems that collectively provide the dynamic application platform 110 for generating the virtual applications 128. For example, the server 102 may be implemented using a cluster of actual and/or virtual servers operating in conjunction with each other, typically in association with conventional network communications, cluster management, load balancing and other features as appropriate. The server 102 operates with any sort of conventional processing hardware 104, such as a processor 105, memory 106, input/output features 107 and the like. The input/output features 107 generally represent the interface(s) to networks (e.g., to the network 145, or any other local area, wide area or other network), mass storage, display devices, data entry devices and/or the like.

The processor 105 may be implemented using any suitable processing system, such as one or more processors, controllers, microprocessors, microcontrollers, processing cores and/or other computing resources spread across any number of distributed or integrated systems, including any number of “cloud-based” or other virtual systems. The memory 106 represents any non-transitory short or long term storage or other computer-readable media capable of storing programming instructions for execution on the processor 105, including any sort of random access memory (RAM), read only memory (ROM), flash memory, magnetic or optical mass storage, and/or the like. The computer-executable programming instructions, when read and executed by the server 102 and/or processor 105, cause the server 102 and/or processor 105 to create, generate, or otherwise facilitate the application platform 110 and/or virtual applications 128 and perform one or more additional tasks, operations, functions, and/or processes described herein. It should be noted that the memory 106 represents one suitable implementation of such computer-readable media, and alternatively or additionally, the server 102 could receive and cooperate with external computer-readable media that is realized as a portable or mobile component or platform, e.g., a portable hard drive, a USB flash drive, an optical disc, or the like.

The server 102, application platform 110 and database systems 130 can be part of one backend system. Although not illustrated, the multi-tenant system 100 can include other backend systems that can include one or more servers that work in conjunction with one or more databases and/or data processing components, and the application platform 110 can access the other backend systems.

The multi-tenant system 100 includes one or more user systems 140 that can access various applications provided by the application platform 110. The application platform 110 is a cloud-based user interface. The application platform 110 can be any sort of software application or other data processing engine that generates the virtual applications 128 that provide data and/or services to the user systems 140. In a typical embodiment, the application platform 110 gains access to processing resources, communications interfaces and other features of the processing hardware 104 using any sort of conventional or proprietary operating system 108. The virtual applications 128 are typically generated at run-time in response to input received from the user systems 140. For the illustrated embodiment, the application platform 110 includes a bulk data processing engine 112, a query generator 114, a search engine 116 that provides text indexing and other search functionality, and a runtime application generator 120. Each of these features may be implemented as a separate process or other module, and many equivalent embodiments could include different and/or additional features, components or other modules as desired.

The runtime application generator 120 dynamically builds and executes the virtual applications 128 in response to specific requests received from the user systems 140. The virtual applications 128 are typically constructed in accordance with the tenant-specific metadata 138, which describes the particular tables, reports, interfaces and/or other features of the particular application 128. In various embodiments, each virtual application 128 generates dynamic web content that can be served to a browser or other client program 142 associated with its user system 140, as appropriate.

The runtime application generator 120 suitably interacts with the query generator 114 to efficiently obtain multi-tenant data 132 from the database 130 as needed in response to input queries initiated or otherwise provided by users of the user systems 140. In a typical embodiment, the query generator 114 considers the identity of the user requesting a particular function (along with the user's associated tenant), and then builds and executes queries to the database 130 using system-wide metadata 136, tenant specific metadata 138, pivot tables 134, and/or any other available resources. The query generator 114 in this example therefore maintains security of the common database 130 by ensuring that queries are consistent with access privileges granted to the user and/or tenant that initiated the request.

With continued reference to FIG. 1, the data processing engine 112 performs bulk processing operations on the data 132 such as uploads or downloads, updates, online transaction processing, and/or the like. In many embodiments, less urgent bulk processing of the data 132 can be scheduled to occur as processing resources become available, thereby giving priority to more urgent data processing by the query generator 114, the search engine 116, the virtual applications 128, etc.

In exemplary embodiments, the application platform 110 is utilized to create and/or generate data-driven virtual applications 128 for the tenants that they support. Such virtual applications 128 may make use of interface features such as custom (or tenant-specific) screens 124, standard (or universal) screens 122 or the like. Any number of custom and/or standard objects 126 may also be available for integration into tenant-developed virtual applications 128. As used herein, “custom” should be understood as meaning that a respective object or application is tenant-specific (e.g., only available to users associated with a particular tenant in the multi-tenant system) or user-specific (e.g., only available to a particular subset of users within the multi-tenant system), whereas “standard” or “universal” applications or objects are available across multiple tenants in the multi-tenant system.

The data 132 associated with each virtual application 128 is provided to the database 130, as appropriate, and stored until it is requested or is otherwise needed, along with the metadata 138 that describes the particular features (e.g., reports, tables, functions, objects, fields, formulas, code, etc.) of that particular virtual application 128. For example, a virtual application 128 may include a number of objects 126 accessible to a tenant, wherein for each object 126 accessible to the tenant, information pertaining to its object type along with values for various fields associated with that respective object type are maintained as metadata 138 in the database 130. In this regard, the object type defines the structure (e.g., the formatting, functions and other constructs) of each respective object 126 and the various fields associated therewith.

Still referring to FIG. 1, the data and services provided by the server 102 can be retrieved using any sort of personal computer, mobile telephone, tablet or other network-enabled user system 140 on the network 145. In an exemplary embodiment, the user system 140 includes a display device, such as a monitor, screen, or another conventional electronic display capable of graphically presenting data and/or information retrieved from the multi-tenant database 130, as described in greater detail below.

Typically, the user operates a conventional browser application or other client program 142 executed by the user system 140 to contact the server 102 via the network 145 using a networking protocol, such as the hypertext transport protocol (HTTP) or the like. The user typically authenticates his or her identity to the server 102 to obtain a session identifier (“SessionID”) that identifies the user in subsequent communications with the server 102. When the identified user requests access to a virtual application 128, the runtime application generator 120 suitably creates the application at run time based upon the metadata 138, as appropriate. However, if a user chooses to manually upload an updated file (through either the web based user interface or through an API), it will also be shared automatically with all of the users/devices that are designated for sharing.

As noted above, the virtual application 128 may contain Java, ActiveX, or other content that can be presented using conventional client software running on the user system 140; other embodiments may simply provide dynamic web or other content that can be presented and viewed by the user, as desired. As described in greater detail below, the query generator 114 suitably obtains the requested subsets of data 132 from the database 130 as needed to populate the tables, reports or other features of the particular virtual application 128.

Objects, Records, and Archive Records

In one embodiment, the multi-tenant database system 130 can store data in the form of records and customizations. As used herein, the term “record” can refer to a particular occurrence or instance of a data object that is created by a user or administrator of a database service and stored in a database system, for example, about a particular (actual or potential) business relationship or project.

By contrast, as used herein, an “archive record” is a change to an instance of an object. For example, an archive record can be defined by a single change to an instance of an object (e.g., a single change to a field of an instance of an object). In other words, an archive record is not a “record that is being archived. Rather, an archive record can be used to describe a record that contains a single change to an instance or an object (e.g., single change to a parent record). For instance, if a tenant had a single transaction where they changed two fields of an instance of an object, then two changes would be recorded; one for each field changed. Each of these two changes would correspond to two archive records (each would be an instance of an archive record). Archive records can also be referred to as field history data for a record.

An object can refer to a structure used to store data and associated metadata along with a globally unique identifier (called an identity field) that allows for retrieval of the object. In one embodiment implementing a multi-tenant database, all of the records for the tenants have an identifier stored in a common table. Each object comprises a number of fields. A record has data fields that are defined by the structure of the object (e.g. fields of certain data types and purposes). An object is analogous to a database table, fields of an object are analogous to columns of the database table, and a record is analogous to a row in a database table. Data is stored as records of the object, which correspond to rows in a database. The terms “object” and “entity” are used interchangeably herein. Objects not only provide structure for storing data, but can also power the interface elements that allow users to interact with the data, such as tabs, the layout of fields on a page, and lists of related records. Objects can also have built-in support for features such as access management, validation, formulas, triggers, labels, notes and attachments, a track field history feature, security features, etc. Attributes of an object are described with metadata, making it easy to create and modify records either through a visual interface or programmatically.

A record can also have custom fields defined by a user. A field can be another record or include links thereto, thereby providing a parent-child relationship between the records. Customizations can include custom objects and fields, Apex Code, Visualforce, Workflow, etc.

Examples of objects include standard objects, custom objects, and external objects. A standard object can have a pre-defined data structure that is defined or specified by a database service or cloud computing platform. A standard object can be thought of as a default object. For example, in one embodiment, a standard object includes one or more pre-defined fields that are common for each organization that utilizes the cloud computing platform or database system or service.

A few non-limiting examples of different types of standard objects can include sales objects (e.g., accounts, contacts, opportunities, leads, campaigns, and other related objects); task and event objects (e.g., tasks and events and their related objects); support objects (e.g., cases and solutions and their related objects); salesforce knowledge objects (e.g., view and vote statistics, article versions, and other related objects); document, note, attachment objects and their related objects; user, sharing, and permission objects (e.g., users, profiles, and roles); profile and permission objects (e.g., users, profiles, permission sets, and related permission objects); record type objects (e.g., record types and business processes and their related objects); product and schedule objects (e.g., opportunities, products, and schedules); sharing and team selling objects (e.g., account teams, opportunity teams, and sharing objects); customizable forecasting objects (e.g., includes forecasts and related objects); forecasts objects (e.g., includes objects for collaborative forecasts); territory management (e.g., territories and related objects associated with territory management); process objects (e.g., approval processes and related objects); content objects (e.g., content and libraries and their related objects); chatter feed objects (e.g., objects related to feeds); badge and reward objects; feedback and performance cycle objects, etc. For example, a record can be for a business partner or potential business partner (e.g. a client, vendor, distributor, etc.) of the user, and can include an entire company, subsidiaries, or contacts at the company. As another example, a record can be a project that the user is working on, such as an opportunity (e.g. a possible sale) with an existing partner, or a project that the user is trying working on.

By contrast, a custom object can have a data structure that is defined, at least in part, by an organization or by a user/subscriber/admin of an organization. For example, a custom object can be an object that is custom defined by a user/subscriber/administrator of an organization, and includes one or more custom fields defined by the user or the particular organization for that custom object. Custom objects are custom database tables that allow an organization to store information unique to their organization. Custom objects can extend the functionality that standard objects provide.

In one embodiment, an object can be a relationship management entity having a record type defined within platform that includes a customer relationship management (CRM) database system for managing a company's relationships and interactions with their customers and potential customers. Examples of CRM entities can include, but are not limited to, an account, a case, an opportunity, a lead, a project, a contact, an order, a pricebook, a product, a solution, a report, a forecast, a user, etc. For instance, an opportunity can correspond to a sales prospect, marketing project, or other business related activity with respect to which a user desires to collaborate with others.

External objects are objects that an organization creates that map to data stored outside the organization. External objects are like custom objects, but external object record data is stored outside the organization. For example, data that's stored on premises in an enterprise resource planning (ERP) system can be accessed as external objects in real time via web service callouts, instead of copying the data into the organization.

For many type of objects, it is desirable to track any changes or modifications made by users to instances of those objects (e.g., track each change to a field that is part of an instance of an object). For instance, a tenant can set field history retention policies on types of objects such as: Accounts, Cases, Contacts, Leads, Opportunities, Assets, Entitlements, Service Contracts, Contract Line Items, Solutions, Products, Price Books, and Custom objects. As an example, Salesforce provides a Field Audit Trail product that lets each tenant define a policy to retain archive records (or field history data), independent of field history tracking. In one embodiment, defining or setting data retention policy involves creating a metadata package and deploying it. The package consists of a .zip file that contains an objects folder with the XML that defines each object's retention policy, and a project manifest that lists the objects and the API version to use. This allows tenants comply with industry regulations related to audit capability and data retention.

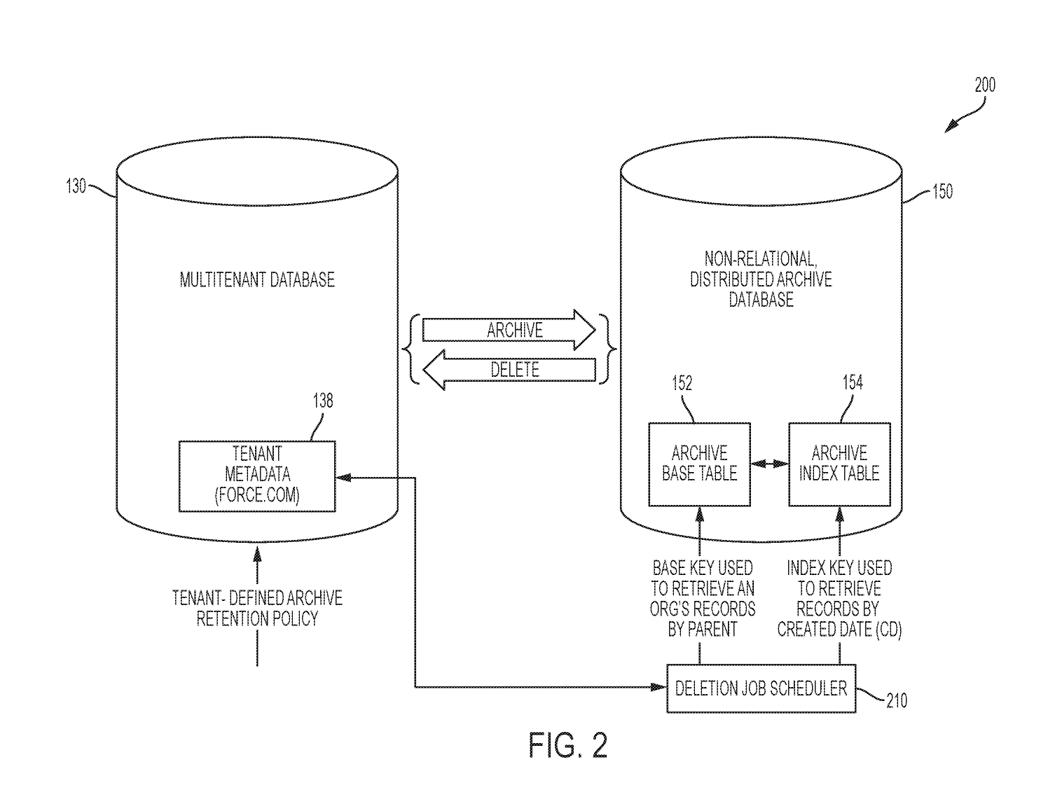

FIG. 2 is a block diagram that illustrates components of a multitenant archive system that is used to archive changes to instances of objects from a multi-tenant database system 130 at a distributed archive database system 150 as archive records in accordance with the disclosed embodiments.

The multi-tenant database system 130 includes tenant metadata 138. As part of this metadata, each tenant can define an archive retention policy that will also be referred to herein as a tenant-defined archive retention policy (ARP) sometimes also referred to as a field history data retention policy (FHARP).

Each tenant can define this tenant-defined archive retention policy for each object type such that changes to instances of objects of a particular object type are stored at the multi-tenant database system 130 for a tenant-defined storage period. The tenant-defined storage period specifies, for each object type, how long changes to instances of objects of that particular object type are to be stored at the multi-tenant database system before being archived as archive records.

The tenant-defined archive retention policy also includes an archive retention period that can be specified by each tenant for each object type (as specified by a parent key prefix). In other words, each tenant can define their own unique or “tenant-defined” archive retention period that is specific for that tenant for each object type. Each tenant-defined archive retention period specifies how long archive records of each object type are to be archived within the distributed archive database system for that tenant before archive records of that object type are deleted from the distributed archive database system.

In one non-limiting embodiment, this tenant-defined storage period can be specified, for example, as a number of months according to one implementation. As such, in one implementation, changes to instances of objects are stored at the multi-tenant database system 130 for an archive after months (AAM) time period (e.g., 1 to 18 months), and then archived at the distributed archive database system 150 where they are retained for a much longer archive retention years (ARY) time period (e.g., 1 to 10 years) that is set by the tenant for each object type. For instance, one example of an archive retention policy could specify archiving the object after six months, and keeping the archives for five years.

The tenant-defined archive retention policies are maintained within the multi-tenant database system 130 as the tenant metadata 138. When the tenant-defined storage period ends, changes to instances of objects that have been stored in the multi-tenant database system 130 will be archived in the distributed archive database system 150 as archive records.

As such, each tenant can define the requirements for retention policies using custom archive deletion policies on a per-object (or per-entity) basis. This allows each tenant to maintain different archive retention lengths for different types of objects (or entities), thus allowing the tenant to have different retention policy combinations (or deletion policies) that vary even within a single tenant.

The distributed archive database system 150 can be a non-relational, distributed database, such as HBase. HBase is a distributed column-oriented database built on top of the Hadoop File System (HDFS). HBase is designed to provide quick random access to huge amounts of structured data. HBase provides fast lookups for larger tables. HBase data stores include one or more tables that are a collection of rows. A row is a collection of column families. A column family is a collection of columns. A column is a collection of key value pairs. Data is stored in rows with columns, and rows can have multiple versions. The tables are indexed by row keys. Row keys are implemented as byte arrays, and are sorted in byte-lexicographical order, which simply means that the row keys are sorted, byte by byte, from left to right. Row keys in HBase are kept sorted lexicographically irrespective of the insertion order. The table schema defines only column families, which are the key value pairs. A table has multiple column families and each column family can have any number of columns. Subsequent column values are stored contiguously on the disk. Each cell value of the table has a timestamp.

As will be described in greater detail below, base keys and row keys are examples of two different indexes, which at the HBase level, essentially boil down to two different tables with identical data, but because the primary keys are different, have the data ordered differently for different use cases. The index key can be used as the primary way to access/delete the data. Any deletions of data in the archive index table 154 are duplicated against the base data in the archive base table 152. As such, both the archive base table 152 and archive index table 154 have the same archive records deleted.

The archive base table 152 stores the original archive records laid out for the general tenant case, where tenants can query archive data using a query pattern specified by a base key Base keys (or keys of the archive base table 152) are used to query and retrieve a tenant's archive records from the archive base table 152. For the general tenant case, the query pattern of the base key is structured to query by a tenant identifier (TENANT_ID) that identifies a particular tenant, a parent key prefix (PARENT_KEY_PREFIX) that specifies the object type (e.g., a three-character identifier that tells the system what type of object or object type the record is), a parent identifier (PARENT_ID)) that specifies an identifier for the actual instance of an object that was changed, and a created date (CREATED_DATE) that indicates a modification date and time on which a change or modification occurred to that instance of object that corresponds to the archive record, and an entity history identifier (ENTITY_HISTORY_ID) that uniquely identifies a specific change.

Once archived at distributed archive database system 150, the archive records will remain archived at the distributed archive database system 150 for the archive retention period. Deletion job scheduler 210 regularly schedules deletion jobs for each tenant for each object type, and deletes any archive records after their tenant-defined archive retention period is expired. In one embodiment, the archive retention period can be specified as a number of years that the archive records are to be archived at the distributed archive database system 150.

Because HBase is a distributed system, it is not multi-tenant by definition. However, the disclosed embodiments provide an optimized multi-tenant deletion framework on HBase that allow HBase to be used in a multi-tenant system so that multi-tenant deletes can be run on HBase. The disclosed embodiments can allow deletions to run over data sets for a single tenant, completely independent, and non-impacting for other tenants. The disclosed embodiments can allow deletions to be scaled, to be resilient, and distributed, all while still maintaining tenant isolation.

The archive index table 154 stores the same archive records as the archive base table 152, but laid out in such a way that it is most efficient for finding archive records that have expired. Index keys (or keys of the secondary index) are used to query and retrieve a tenant's archive records from archive index table 154. In accordance with the disclosed embodiments, deletion job scheduler 210 queries the archive index table 154 of the distributed archive database system 150 and retrieves archive records stored in the distributed archive database system 150 by created date (i.e., according to the date and time the corresponding object was changed or modified).

In contrast to the base key, the fields that make up the index key are altered (re-ordered or arranged) in an optimal way to optimize the query pattern used in the deletion process. The index key is arranged according to a query pattern that includes a tenant identifier (TENANT_ID) field, a parent key prefix (PARENT_KEY_PREFIX) field, a created date (CREATED_DATE) field, a parent identifier (PARENT_ID), and an entity history identifier (ENTITY_HISTORY_ID). The tenant or organization identifier (TENANT_ID) field specifies the tenant. The parent key prefix (PARENT_KEY_PREFIX) specifies the object type. The created date (CREATED_DATE) field indicates a modification date and time on which a change or modification occurred to that instance of object that corresponds to the archive record. In other words, the created date of an archive record is the date and time on which the change occurred to the parent object record. It should be noted that in many cases that the created date may indicate when the archive record was created, but in some case the created date is not the date that a record was initially archived at distributed archive database system 150. The parent identifier (PARENT_ID) specifies an identifier for the actual instance of an object that was changed. The entity history identifier (ENTITY_HISTORY_ID) that uniquely identifies a specific change.

The oldest archive records associated with a certain tenant identifier (TENANT_ID) field, a certain parent key prefix (PARENT_KEY_PREFIX) field and a certain parent identifier (PARENT_ID) can be ordered so that the oldest archive records that are eligible for deletion can be found based on their created date (CREATED_DATE) field. To explain further, because HBase is laid out lexicographically, by structuring the index key by tenant identifier (TENANT_ID), parent key prefix (PARENT_KEY_PREFIX), created date (CREATED_DATE), parent identifier (PARENT_ID) and an entity history identifier (ENTITY_HISTORY_ID), the query pattern is changed so that the index key can be used to find archive records, that are already sorted on disk, by the oldest archive records down to the newest archive records in the deletion window. Stated differently, the query pattern of the index key is arranged to find the oldest archive records in the deletion window sorted by created date in descending order down to the newest archive records in the deletion window so that archive records that are more likely to be expired are found first. As such, the index key allows for the created date to be determined more efficiently. All of the changes to instances of objects can be sorted by created date (e.g., oldest first down to newest based on created date) in the deletion window so that archive records that are more likely to be expired are found first. The oldest changes to a specific tenant's object type are arranged at the top of the deletion window and the newest changes are at the bottom of the deletion window. As such the index key can be used to efficiently find each tenant's archive records that have a particular object type by the date and time the archive record was created.

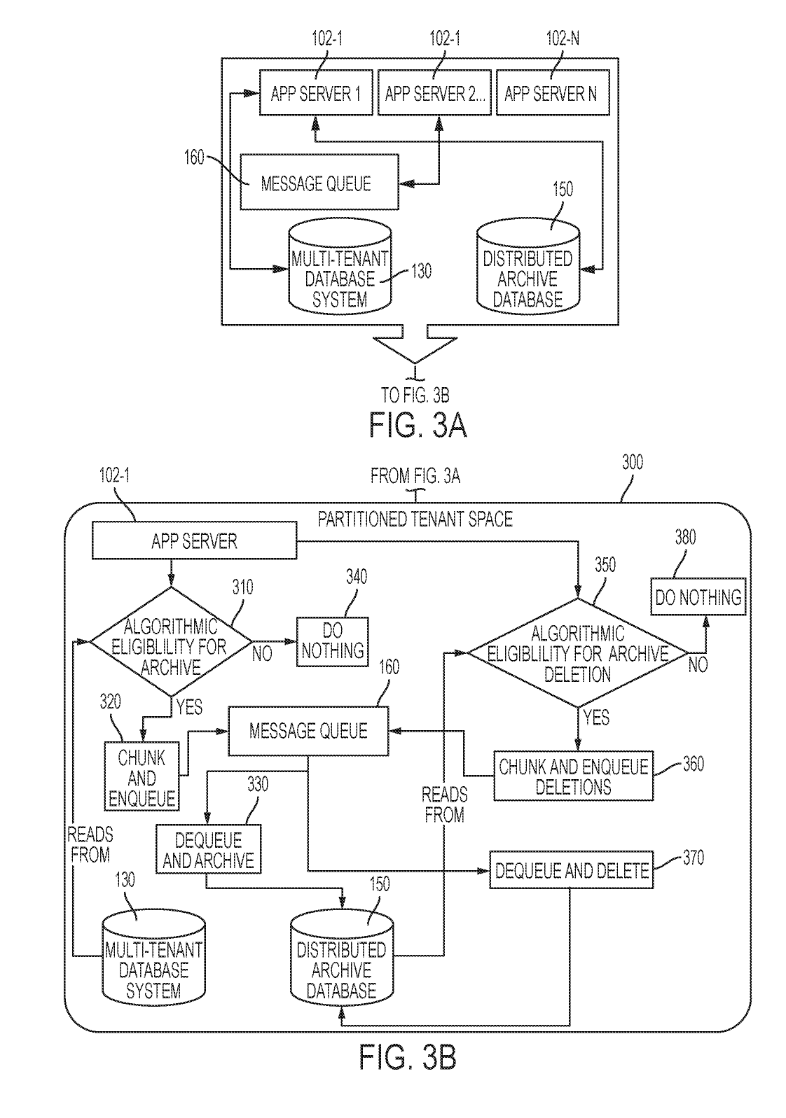

FIG. 3A is a block diagram that illustrates components of an archive system that are used to archive changes to instances of objects from a multi-tenant database system 130 as archive records at a distributed archive database system 150 in accordance with the disclosed embodiments. As shown, the simplified archive architecture includes a number of application servers 102-1 . . . 102-N, the multi-tenant database system 130, and the distributed archive database system 150 that were described above with respect to FIG. 2. In addition, the system also includes the message queue 160.

FIG. 3B is a flow diagram that illustrates archival operations within a partitioned tenant space 300 in accordance with the disclosed embodiments. As shown in FIG. 3B, the simplified archive architecture of FIG. 3A can be abstracted to a partitioned tenant space 300. This partitioned tenant space 300 will be used to describe the general processes for archiving changes to instances of objects of particular tenant at the distributed archive database system 150 as archive records, and then deleting those archive records of the particular tenant from the distributed archive database system 150.

Processing that takes place during the archival job is shown at blocks 310, 320, 330. At 310, changes to instances of objects maintained at the multi-tenant database system 130 are read from the multi-tenant database system 130 and evaluated for archive eligibility. Any changes to instances of objects that are eligible for archive eligibility are chunked and enqueued at 320 and provided to message queue 160. At 330, those changes to instances of objects are dequeued and then archived at the distributed archive database system 150 as archive records for the tenant-defined archive retention period, which as noted above could be set for a number of years. As shown at 340, any changes to instances of objects that are determined to not yet be eligible for archiving (at 310) because they had not yet been stored for longer than their tenant-defined storage period will remain stored at the multi-tenant database system 130.

Processing that takes place during a deletion job is shown at blocks 350, 360, 370. The multi-tenant database system 130 stores information on the deletion jobs such as state of the job (running, queued, finished, etc.), how many records have been deleted, etc. Actual deletions are run on the distributed archive database system 150. Deletion jobs are scheduled to run periodically (e.g., once every night). When a deletion job runs, an application server 102-1 starts the deletion job, and determines candidate tenants for archive deletion, and then for each of the tenant's object types, and calculates a date range for which archive records should be deleted. At 350, archive records are read from the distributed archive database system 150 to determine whether they are eligible to be deleted from the distributed archive database system 150. For any archive records that are not yet eligible for deletion from the distributed archive database system 150 those archive records will be maintained at the distributed archive database system 150 until their archive retention period expires as shown at 380.

For any archive records that are eligible for deletion from the distributed archive database system 150, those archive records will be chunked and enqueued for deletion at 360. In other words, the archive records that are eligible for deletion from the distributed archive database system 150 will be chunked and enqueued at message queue 160, and will then be dequeued and deleted at 370. The application server 102-1 creates one or more messages with deletion information in the payload that specifies the criteria defining which archive records are to be deleted, and enqueues the messages on the message queue 160 for each and every candidate organization/object type. FIG. 3B covers the flow of an application server 102-1 as it processes a single one of these messages. Each of these messages goes into a single message queue 160. This means there could be thousands or even millions of messages queued on the message queue (one message for each eligible tenant/object type). A given pod can include multiple application servers 102-1 . . . 102-N, each of which can dequeue one of the messages on the message queue 160, then process the individual dequeued message. Each message process deletes one page's worth of expired archive records for a tenant/object type. If there are too many archive records (i.e., more data to delete for that tenant/object type), then the application server will enqueue another message that specifies those additional archive records. In general, when a message is dequeued at 370, if an exception occurs during any time during that flow (expected or unexpected), the message fails, and is either dropped entirely if the error was unrecoverable, or if the exception indicates the error will be eventually correctable (i.e., a transient error occurred like a table of the distributed archive database system 150 being temporary offline), the message is put in the back of the queue with a timed retry, meaning that even if it makes it to the front of the queue, it won't be processed until a certain amount of time has gone by. This process allows for deletions for each tenant to be isolated, and even each tenant's object types on the distributed archive database system 150.

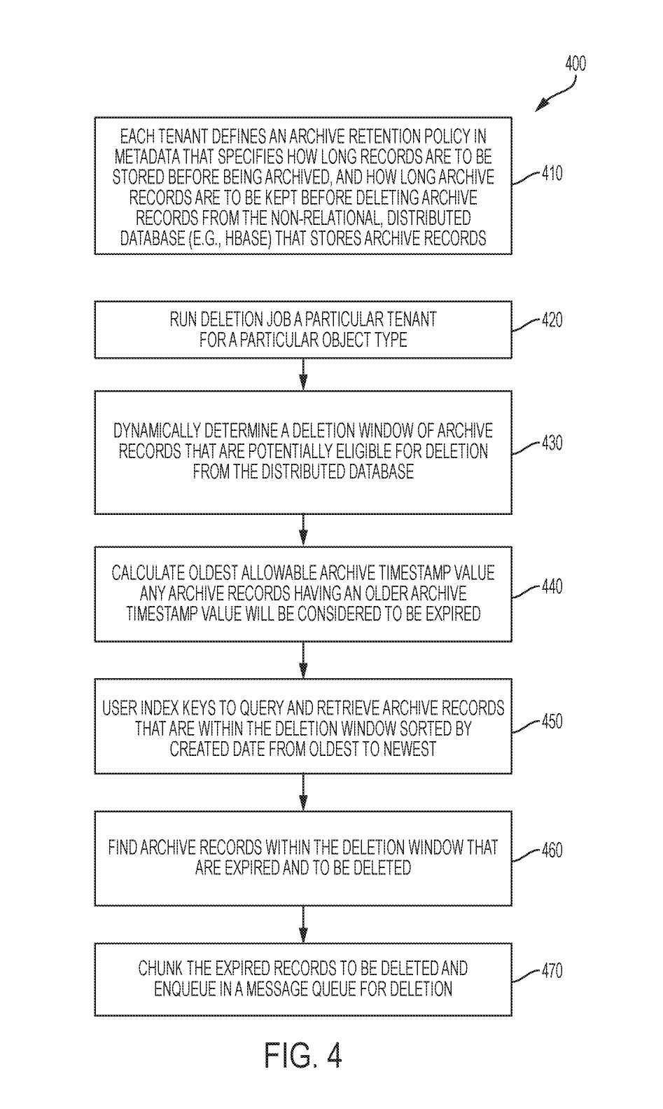

In accordance of the disclosed embodiments, a method for deletion of archive records after expiration of the tenant-defined archive retention period is provided as will now be described with reference to FIGS. 4-7.

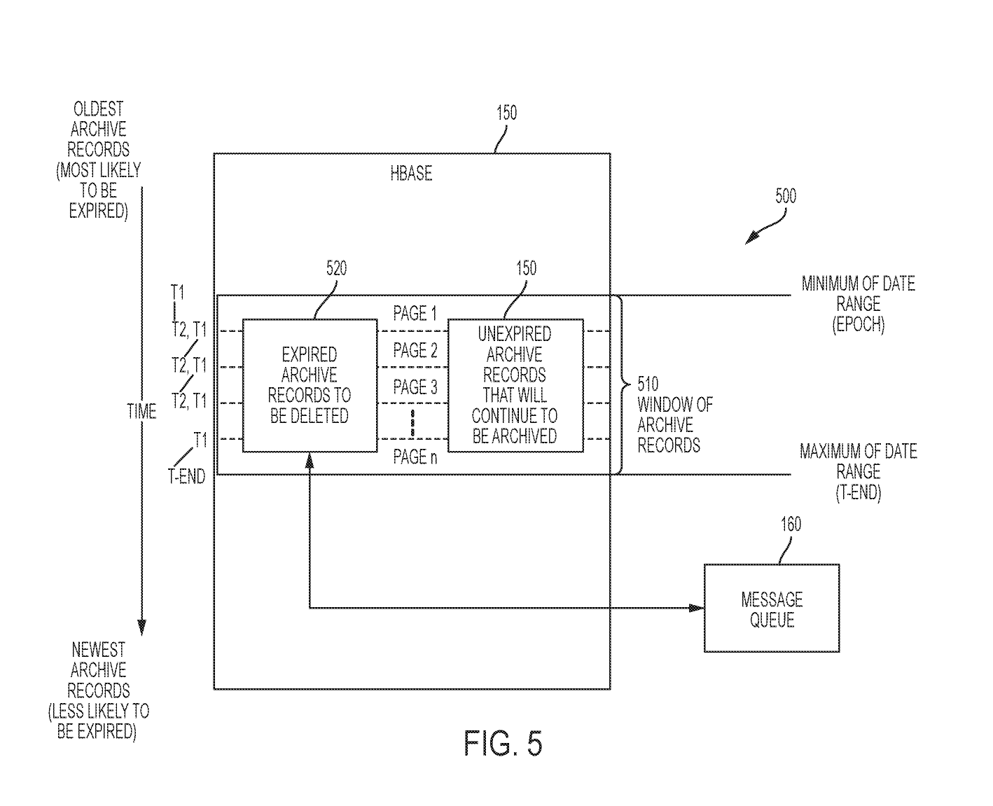

FIG. 4 is a flowchart that illustrates an exemplary method 400 for deleting archive records from a distributed archive database system 150 in accordance with the disclosed embodiments. The method 400 will be described below with continued reference to FIG. 1-3B, and with reference to FIGS. 5-7.

It should be understood that steps of the method 400 are not necessarily limiting, and that steps can be added, omitted, and/or performed simultaneously without departing from the scope of the appended claims. It should be appreciated that the method 400 may include any number of additional or alternative tasks, that the tasks shown in FIG. 4 need not be performed in the illustrated order, and that the method 400 may be incorporated into a more comprehensive procedure or process having additional functionality not described in detail herein. Moreover, one or more of the tasks shown in FIG. 4 could potentially be omitted from an embodiment of the method 400 as long as the intended overall functionality remains intact. It should also be understood that the illustrated method 400 can be stopped at any time, for example, by disabling or cancelling it. The method 400 is computer-implemented in that various tasks or steps that are performed in connection with the method 400 may be performed by software, hardware, firmware, or any combination thereof. For illustrative purposes, the following description of the method 400 may refer to elements mentioned above in connection with FIGS. 1-3B. In certain embodiments, some or all steps of this process, and/or substantially equivalent steps, are performed by execution of processor-readable instructions stored or included on a processor-readable medium. For instance, in the description of FIG. 4 that follows, the multi-tenant database system 130, the distributed archive database system 150 and the deletion job scheduler 210 can be described as performing various acts, tasks or steps, but it should be appreciated that this refers to processing system(s) of these entities executing instructions to perform those various acts, tasks or steps. Depending on the implementation, some of the processing system(s) can be centrally located, or distributed among a number of systems that work together.

Prior to the start of the method at 420, each tenant defines an archive retention policy (at 410) within tenant metadata 138 that is maintained at multi-tenant database system 130. However, because the archive retention policy can be defined or re-defined at any time, step 410 can be performed at any time before or after running a deletion job at deletion job scheduler 210. As noted above, this archive retention policy specifies how long changes to instances of objects are to be stored before being archived distributed archive database system 150 as archive records, and an archive retention period that indicates how long the archive records are to be archived at the distributed archive database system 150 before deleting them from the distributed archive database system 150.

At 420, the deletion job scheduler 210 runs a deletion job for archive records of a tenant that have a particular object type. In one embodiment, the deletion job scheduler 210 can periodically run a deletion job for each object type for each tenant. Depending on the implementation, periodically can mean, for example, once per year, once per month, once per week, once per day, once per hour, once per minute, or even on demand. For instance, in one implementation, the deletion job can be run nightly for each tenant/org for each object type. It should be noted that the deletion job scheduler 210 can be distributed over many HBase nodes, and that the system can enqueue thousands of deletion jobs at the same time and that each of these jobs can be run at the same time in parallel. However, for sake of simplicity, the description that follows will focus on a single deletion job for a single tenant and object type.

In accordance with the disclosed embodiments, the deletion jobs for each tenant can be isolated from deletion jobs of other tenants. Tenant deletions are isolated, so if there were a logical or non-environmental failure for one tenant's deletion job, it would not impact any other tenants. In addition, deletes recover automatically if there is an environment failure. Or, in the case that a specific HBase node were down, other tenants on other HBase nodes would be unaffected, and would continue to have deletions perform. To explain further, due to the nature of the distributed system, multiple failures could potentially occur. Since the archived data for a single tenant may be hosted on a single HBase node, and if the node were down, that specific deletion job would fail and automatically retry a number of seconds or minutes later to give HBase a chance to automatically recover. During this time, other messages for other tenant's whose data may exist on other HBase nodes can continue to be processed. Furthermore, if the entire HBase node cluster went down, all messages would fail, and begin to retry in a number of seconds or minutes. Because the archive deletion job will attempt multiple retries if HBase is temporarily down, the deletion process is resilient to failures. Yet another form of recovery would be if there were an exception in how the data were laid out for a single organization/object type: that failure would cause the job to end in a fail state, but otherwise would not effect deletion jobs running for other tenants (or even deletion jobs for that same organization's other object types).

At 430, the deletion job scheduler 210 can dynamically determine a deletion window of archive records (of a particular tenant and of a particular object type) that are potentially eligible for deletion from the distributed archive database system 150. This deletion window has an upper bound and a lower bound so that only the records that are potentially eligible for deletion from the distributed archive database system 150 are queried/searched. In other words, the deletion window includes only the archive records that have created dates that are in a range greater than or equal to a minimum lower boundary date (T1) and less than a maximum upper boundary date (T-END) so that only the archive records that are potentially eligible for deletion from the distributed archive database system 150 are queried. As such, the system only needs to scan part of the distributed archive database system 150 (i.e., a full scan of the tables that make up the distributed archive database system 150 is not required).

The minimum lower boundary date (T1) is an ultimate lower boundary date. In other words, the minimum lower boundary date (T1) is defined based on a lower bound of any created date eligible for deletion. The minimum lower boundary date (T1) could be set to any other arbitrary starting point in time when no records could exist. In one embodiment, the minimum lower boundary date (T1) can initially be set to epoch (e.g. Jan. 1, 1970).

The maximum upper boundary date (T-END) is the latest possible archive date that should be deleted (e.g., a limit when the querying across the index for a given deletion). The deletion job scheduler 210 will delete all archive records with archive timestamp values that are older than or equal to maximum upper boundary date (T-END). The maximum upper boundary date (T-END) is an upper bound of the range before which an archive timestamp of an archive record is not eligible for deletion, and is defined based on the difference between: the date the deletion job is run and the oldest allowable archive timestamp value and tenant-defined archive retention period (that specifies how long archive records of the particular object type are to be archived). The deletion window will be described in greater detail below with reference to FIG. 5.

Method 400 then proceeds to 440, where the deletion job scheduler 210 calculates an oldest allowable archive timestamp value. The oldest allowable archive timestamp value is equal to a difference between a current date and time when the deletion job runs and the archive retention period. This oldest allowable archive timestamp value defines a point in time (e.g., date and time) where any archive record that has an archive timestamp less than the oldest allowable archive timestamp value will be considered to be expired and ready for deletion.

Method 400 then proceeds to 450, where the deletion job scheduler 210 uses index keys (described above) to query and retrieve archive records within the deletion window based on their created date. For example, in one embodiment, the deletion job scheduler 210 uses index keys to query the distributed archive database system for archive records that are within the deletion window and belong to the tenant, and retrieves the archive records, that are within the deletion window and belong to the tenant, such that the archive records that belong to the tenant are ordered from oldest to newest based on their respective created dates. Stated differently, the same secondary index is used for each and every organization/object type such that all queries for deletion (both initial queries against the data, then subsequent pages through the data) use the same secondary index.

Method 400 then proceeds to 460, where the deletion job scheduler 210 finds or identifies the archive records within the deletion window that have expired, and then marks those expired records for deletion. The archive records that are determined to be within the deletion window are expired when they have they have an archive timestamp value that is less than the oldest allowable archive timestamp.

Method 400 then proceeds to 470, where the deletion job scheduler 210 splits or chunks expired records that are to be deleted into groups (or batches), and enqueues those groups of expired records in the message queue 160 for deletion. The groups of expired records will then be dequeued and deleted from the distributed archive database system 150.

The message queue 160 is used to ensure fairness among tenants during deletion processing, while also allowing for failure recovery. In other words, archive records to be deleted for a particular tenant are split into small batches or chunks (prior to deletion) so if one tenant has a long running delete job, other tenants delete jobs are run in parallel and are not impacted. As such, in accordance with the disclosed embodiments, deletions have fair-share built in.

FIG. 5 illustrates the concept of a deletion window in accordance with the disclosed embodiments. As shown in FIG. 5, if all the archive records of a particular object type that are stored in the distributed archive database system 150 for particular tenant are time sorted based on their created date from oldest to newest, many of those archive records that are archived at the distributed archive database system 150 cannot possibly be eligible for deletion. Rather, only a certain group that fall within the deletion window 510 can potentially be eligible for deletion. As will be described in greater detail below, a deletion window 510 can be determined that has some minimum creation date range and some maximum creation date range, and archive records of a particular object type that fall within that deletion window 510 are potentially eligible for deletion, whereas other archive records within distributed archive database system 150 could not possibly ever be eligible for deletion.

Within the deletion window, some of the archive records 520 will have expired and should be deleted, while others 530 that are potentially eligible for deletion have not. Archive records to be deleted are represented conceptually by block 520. However, other archive records, represented by block 530, that fall within the deletion window 510 have not yet expired and should continue to be archived at distributed archive database system 150. When the tenant has a large volume of expired records of a particular object type that fall within the deletion window 510, the expired records for that particular tenant can be grouped into smaller batches (e.g., 10000 records of object type 1 for tenant 1, 10000 records of object type 1 for tenant 2, 10000 records of object type 1 for tenant 3, etc) before being passed to the message queue 160 where they will be dequeued and deleted. As described above at 470, the expired records that fall within the deletion window 510 will be chunked and passed to the message queue 160 where they will be dequeued and deleted from the distributed archive database system 150.

As described herein, the very first page of the deletion window will be defined by a minimum lower boundary date (T1) and a time (T2). The first instance of time (T1) can be epoch, and the second time (T2) will be a page limit. Then, for the next limit bounded page, the second time (T2) becomes the new instance of time (T1) that is the start of the new limit bounded page and a new time (T2) becomes the end of the new limit bounded page. The last limit bounded page will have a final time (T2) that is the maximum upper boundary date (T-END). The maximum upper boundary date (T-END) is the maximum upper bound when querying across the index key for a given deletion job (for a specific tenant and object type).

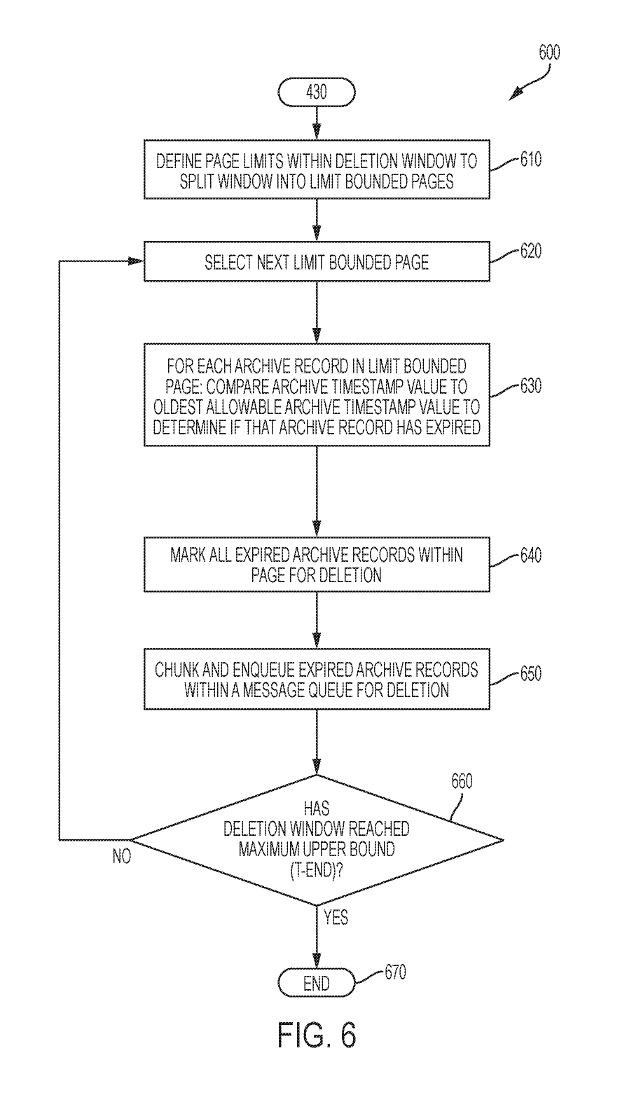

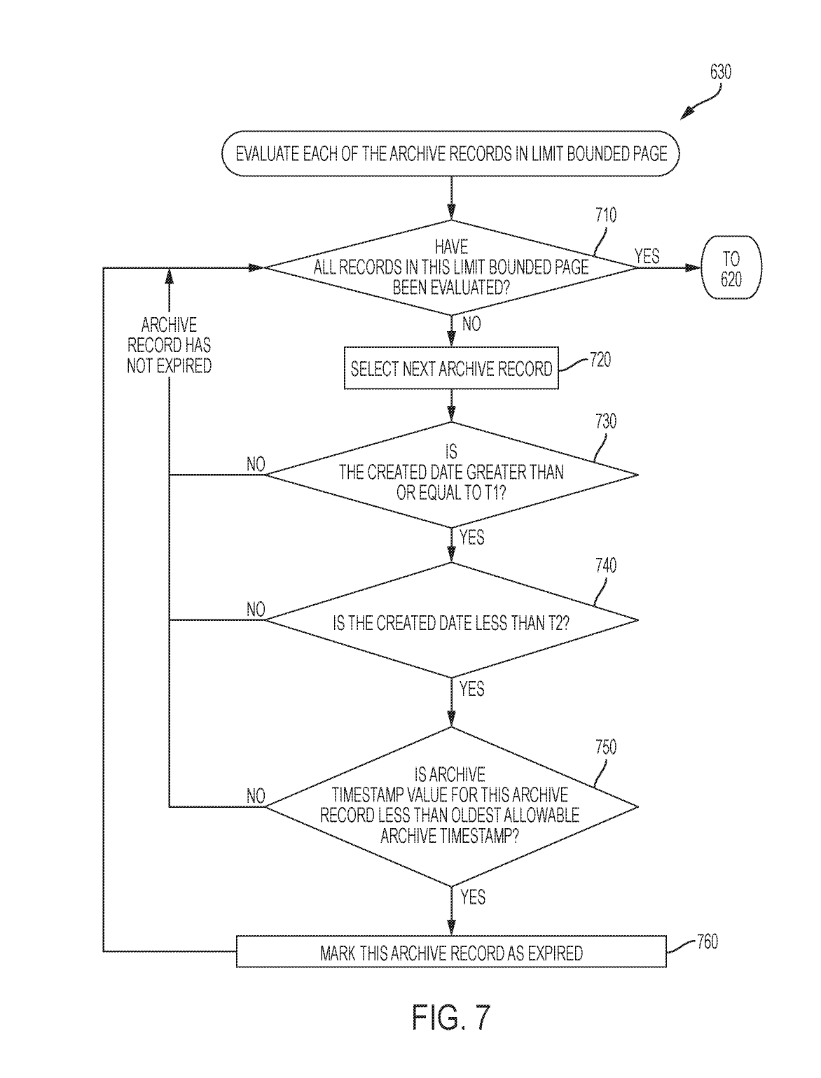

Details of one implementation of FIG. 5 will be explained in greater detail below with reference to FIGS. 6 and 7.

FIG. 6 is a flowchart that illustrates an exemplary method 600 for deleting archive records from the distributed archive database system 150 in accordance with the disclosed embodiments. The method 600 will be described below with continued reference to FIG. 1-4, and with reference to FIG. 7. Method 600 can be performed within the context of FIG. 4 at any point after 440 of FIG. 4 in accordance with the disclosed embodiments.

It should be understood that steps of the method 600 are not necessarily limiting, and that steps can be added, omitted, and/or performed simultaneously without departing from the scope of the appended claims. It should be appreciated that the method 600 may include any number of additional or alternative tasks, that the tasks shown in FIG. 6 need not be performed in the illustrated order, and that the method 600 may be incorporated into a more comprehensive procedure or process having additional functionality not described in detail herein. Moreover, one or more of the tasks shown in FIG. 6 could potentially be omitted from an embodiment of the method 600 as long as the intended overall functionality remains intact. It should also be understood that the illustrated method 600 can be stopped at any time, for example, by disabling or cancelling it. The method 600 is computer-implemented in that various tasks or steps that are performed in connection with the method 600 may be performed by software, hardware, firmware, or any combination thereof. For illustrative purposes, the following description of the method 600 may refer to elements mentioned above in connection with FIGS. 1-3B. In certain embodiments, some or all steps of this process, and/or substantially equivalent steps, are performed by execution of processor-readable instructions stored or included on a processor-readable medium. For instance, in the description of FIG. 6 that follows, the multi-tenant database system 130, the distributed archive database system 150 and the deletion job scheduler 210 can be described as performing various acts, tasks or steps, but it should be appreciated that this refers to processing system(s) of these entities executing instructions to perform those various acts, tasks or steps. Depending on the implementation, some of the processing system(s) can be centrally located, or distributed among a number of systems that work together.

After the deletion window is been defined at 430, at 610 the deletion window can be split into limit bounded pages that each range from T1 to T2. At 610, page limits are defined within the deletion window to split the deletion window into a set of bounded pages. This is illustrated conceptually FIG. 5 where the deletion window 510 has been split into pages 1 through n. In one embodiment, each page includes a batch of archive records of a particular object type for a particular tenant. For example, page 1 can include archive records of an opportunity object for tenant 1. Page 2 can include archive records of an opportunity object for tenant 1. Page n can include archive records of an opportunity object for tenant 1. This deletion processing can be repeated in parallel for each object type for each tenant, and a deletion window can be defined for each tenant and object type.

The method 600 then proceeds to 620, where the next limit bounded page is selected. At 630, an archive timestamp value for each archive record in this limit bounded page can be compared to the oldest allowable archive timestamp value (that was calculated at 440) to determine whether that archive record has expired. The oldest allowable archive timestamp value is the current date and time when deletion job runs minus the tenant's archive retention period. The archive timestamp value indicates a date and time when a change occurred to a corresponding object that reflects when that particular archive record should have been archived. As such, the archive timestamp value for each record can be used to determine whether an archive record has expired and should be deleted. One implementation of 630 will be described below with reference to FIG. 7, which describes how each archive record is evaluated to determine if that archive record is expired.

After each archive record within the limit bounded page has been evaluated at 630, all of the expired records within the limit bounded page are marked for deletion at 640.

At 650, the expired records that have been marked for deletion are then chunked and enqueued in a message queue for deletion as described above. At 660, the deletion job scheduler 210 determines whether the deletion window has reached its maximum upper boundary date (T-END). When the deletion job scheduler 210 determines that the deletion window has reached its maximum upper boundary date (T-END) at 660, this means that there are no more limit bounded pages within the deletion window to be processed, and the method 600 proceeds to 670 where the method 600 ends. On the other hand, when the deletion job scheduler 210 determines (at 660) that the deletion window has not yet reached its maximum upper boundary date (T-END), the method 600 loops back to 620 where the deletion job scheduler 210 selects the next limit bounded page that is to be processed, and the next limit bounded page is then processed at 630 through 660 as described above. Method 600 continues this process of selecting the next limit bounded page (at 620) until the deletion window reached its maximum upper boundary date (T-END) at 660.

FIG. 7 is a flowchart that illustrates an exemplary method 630 for evaluating archive records in a limit bounded page to determine whether archive records have expired and should be deleted in accordance with in accordance with the disclosed embodiments. The method 630 will be described below with continued reference to FIG. 1-6.

It should be understood that steps of the method 630 are not necessarily limiting, and that steps can be added, omitted, and/or performed simultaneously without departing from the scope of the appended claims. It should be appreciated that the method 630 may include any number of additional or alternative tasks, that the tasks shown in FIG. 7 need not be performed in the illustrated order, and that the method 630 may be incorporated into a more comprehensive procedure or process having additional functionality not described in detail herein. Moreover, one or more of the tasks shown in FIG. 7 could potentially be omitted from an embodiment of the method 630 as long as the intended overall functionality remains intact. It should also be understood that the illustrated method 630 can be stopped at any time, for example, by disabling or cancelling it. The method 630 is computer-implemented in that various tasks or steps that are performed in connection with the method 630 may be performed by software, hardware, firmware, or any combination thereof. For illustrative purposes, the following description of the method 630 may refer to elements mentioned above in connection with FIGS. 1-3B. In certain embodiments, some or all steps of this process, and/or substantially equivalent steps, are performed by execution of processor-readable instructions stored or included on a processor-readable medium. For instance, in the description of FIG. 7 that follows, the multi-tenant database system 130, the distributed archive database system 150 and the deletion job scheduler 210 can be described as performing various acts, tasks or steps, but it should be appreciated that this refers to processing system(s) of these entities executing instructions to perform those various acts, tasks or steps. Depending on the implementation, some of the processing system(s) can be centrally located, or distributed among a number of server systems that work together.

Each time an archive record has been processed the deletion job scheduler 210 determines, at 710, whether all archive records in this particular limit bounded page of been evaluated. The deletion job processing that is performed in FIG. 7 can be repeated until each archive record within a limit bounded page has been evaluated. If all archive records in this particular limit bounded page have been evaluated, the method 630 proceeds to 620 of FIG. 6 as described above.

When the deletion job scheduler 210 determines at 710 that all archive records in this limit bounded page not yet been evaluated, the method 630 proceeds to 720, where the deletion job scheduler 210 selects the next archive record to be processed. At 730, the deletion job scheduler 210 determines whether the created date of this archive record is greater than or equal to a lower bound of the page (T1). If the created date is not greater than or equal to the lower bound of the page (T1), this means that the archive record fell within the bounds of a previously processed page and the method 630 loops back to 710.

When it's determined that the created date of this archive record is greater than or equal to the lower bound of the page (T1), the method 630 proceeds to 740, where the deletion job scheduler 210 determines whether the created date of this archive record is less than the upper bound of the page (T2). When it is determined at 740 that the created date of this archive record is less than the upper bound of the page (T2), the method 630 proceeds to 750. When is determined at 740 that the created date of this archive record is not less than the upper bound of the page (T2), this means that the archive record could not yet be expired, and the method 630 loops back 710.

At 750, the deletion job scheduler 210 determines whether the archive timestamp value for this archive record is less than in the oldest allowable archive timestamp value. The oldest allowable archive timestamp value is equal to the difference between the current date and time when the deletion job runs and the tenant-defined archive retention period. When the deletion job scheduler 210 determines that the archive timestamp value is less than the oldest allowable archive timestamp value, the method 630 proceeds to 760 where this archive record is marked as expired, and the method 630 the loops back to 710.

By contrast, when the deletion job scheduler 210 determines that the archive timestamp value of this archive record is not less than the oldest allowable archive timestamp value, this means that the archive records has not expired, and the method 630 loops back 710.

The following description is of one example of a system in which the features described above may be implemented. The components of the system described below are merely one example and should not be construed as limiting. The features described above with respect to FIGS. 1-7 may be implemented in any other type of computing environment, such as one with multiple servers, one with a single server, a multi-tenant server environment, a single-tenant server environment, or some combination of the above.

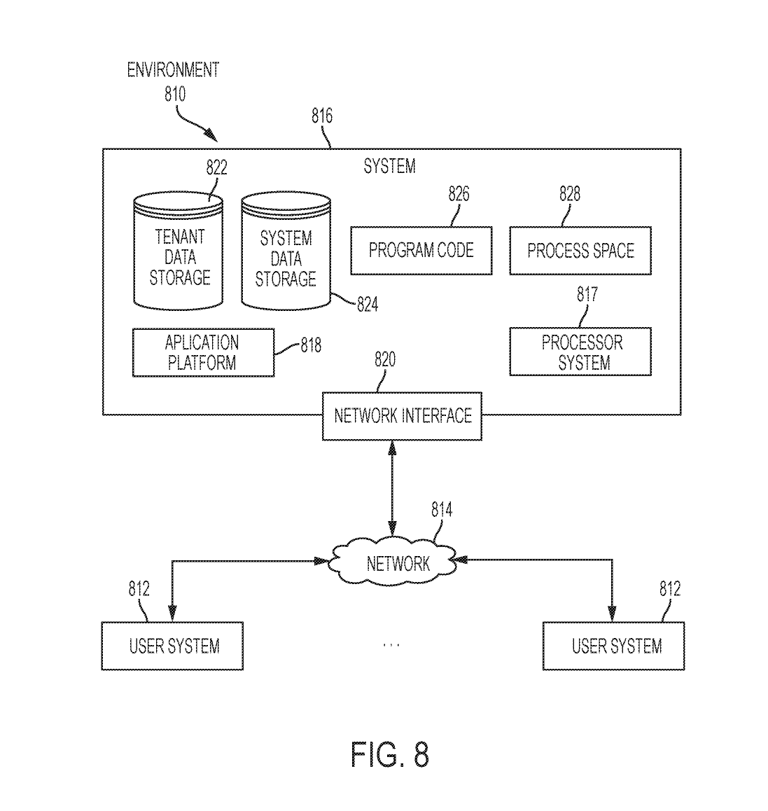

FIG. 8 shows a block diagram of an example of an environment 810 in which an on-demand database service can be used in accordance with some implementations. The environment 810 includes user systems 812, a network 814, a database system 816 (also referred to herein as a “cloud-based system”), a processor system 817, an application platform 818, a network interface 820, tenant database 822 for storing tenant data 823, system database 824 for storing system data 825, program code 826 for implementing various functions of the system 816, and process space 828 for executing database system processes and tenant-specific processes, such as running applications as part of an application hosting service. In some other implementations, environment 810 may not have all of these components or systems, or may have other components or systems instead of, or in addition to, those listed above.

In some implementations, the environment 810 is an environment in which an on-demand database service exists. An on-demand database service, such as that which can be implemented using the system 816, is a service that is made available to users outside of the enterprise(s) that own, maintain or provide access to the system 816. As described above, such users generally do not need to be concerned with building or maintaining the system 816. Instead, resources provided by the system 816 may be available for such users' use when the users need services provided by the system 816; that is, on the demand of the users. Some on-demand database services can store information from one or more tenants into tables of a common database image to form a multi-tenant database system (MTS). The term “multi-tenant database system” can refer to those systems in which various elements of hardware and software of a database system may be shared by one or more customers or tenants. For example, a given application server may simultaneously process requests for a great number of customers, and a given database table may store rows of data such as feed items for a potentially much greater number of customers. A database image can include one or more database objects. A relational database management system (RDBMS) or the equivalent can execute storage and retrieval of information against the database object(s).

Application platform 818 can be a framework that allows the applications of system 816 to execute, such as the hardware or software infrastructure of the system 816. In some implementations, the application platform 818 enables the creation, management and execution of one or more applications developed by the provider of the on-demand database service, users accessing the on-demand database service via user systems 812, or third party application developers accessing the on-demand database service via user systems 812.

In some implementations, the system 816 implements a web-based customer relationship management (CRM) system. For example, in some such implementations, the system 816 includes application servers configured to implement and execute CRM software applications as well as provide related data, code, forms, renderable web pages and documents and other information to and from user systems 812 and to store to, and retrieve from, a database system related data, objects, and Web page content. In some MTS implementations, data for multiple tenants may be stored in the same physical database object in tenant database 822. In some such implementations, tenant data is arranged in the storage medium(s) of tenant database 822 so that data of one tenant is kept logically separate from that of other tenants so that one tenant does not have access to another tenant's data, unless such data is expressly shared. The system 816 also implements applications other than, or in addition to, a CRM application. For example, the system 816 can provide tenant access to multiple hosted (standard and custom) applications, including a CRM application. User (or third party developer) applications, which may or may not include CRM, may be supported by the application platform 818. The application platform 818 manages the creation and storage of the applications into one or more database objects and the execution of the applications in one or more virtual machines in the process space of the system 816.

According to some implementations, each system 816 is configured to provide web pages, forms, applications, data and media content to user (client) systems 812 to support the access by user systems 812 as tenants of system 816. As such, system 816 provides security mechanisms to keep each tenant's data separate unless the data is shared. If more than one MTS is used, they may be located in close proximity to one another (for example, in a server farm located in a single building or campus), or they may be distributed at locations remote from one another (for example, one or more servers located in city A and one or more servers located in city B). As used herein, each MTS could include one or more logically or physically connected servers distributed locally or across one or more geographic locations. Additionally, the term “server” is meant to refer to a computing device or system, including processing hardware and process space(s), an associated storage medium such as a memory device or database, and, in some instances, a database application (for example, OODBMS or RDBMS) as is well known in the art. It should also be understood that “server system” and “server” are often used interchangeably herein. Similarly, the database objects described herein can be implemented as part of a single database, a distributed database, a collection of distributed databases, a database with redundant online or offline backups or other redundancies, etc., and can include a distributed database or storage network and associated processing intelligence.

The network 814 can be or include any network or combination of networks of systems or devices that communicate with one another. For example, the network 814 can be or include any one or any combination of a LAN (local area network), WAN (wide area network), telephone network, wireless network, cellular network, point-to-point network, star network, token ring network, hub network, or other appropriate configuration. The network 814 can include a TCP/IP (Transfer Control Protocol and Internet Protocol) network, such as the global internetwork of networks often referred to as the “Internet” (with a capital “I”). The Internet will be used in many of the examples herein. However, it should be understood that the networks that the disclosed implementations can use are not so limited, although TCP/IP is a frequently implemented protocol.

The user systems 812 can communicate with system 816 using TCP/IP and, at a higher network level, other common Internet protocols to communicate, such as HTTP, FTP, AFS, WAP, etc. In an example where HTTP is used, each user system 812 can include an HTTP client commonly referred to as a “web browser” or simply a “browser” for sending and receiving HTTP signals to and from an HTTP server of the system 816. Such an HTTP server can be implemented as the sole network interface 820 between the system 816 and the network 814, but other techniques can be used in addition to or instead of these techniques. In some implementations, the network interface 820 between the system 816 and the network 814 includes load sharing functionality, such as round-robin HTTP request distributors to balance loads and distribute incoming HTTP requests evenly over a number of servers. In MTS implementations, each of the servers can have access to the MTS data; however, other alternative configurations may be used instead.

The user systems 812 can be implemented as any computing device(s) or other data processing apparatus or systems usable by users to access the database system 816. For example, any of user systems 812 can be a desktop computer, a work station, a laptop computer, a tablet computer, a handheld computing device, a mobile cellular phone (for example, a “smartphone”), or any other Wi-Fi-enabled device, wireless access protocol (WAP)-enabled device, or other computing device capable of interfacing directly or indirectly to the Internet or other network. The terms “user system” and “computing device” are used interchangeably herein with one another and with the term “computer.” As described above, each user system 812 typically executes an HTTP client, for example, a web browsing (or simply “browsing”) program, such as a web browser based on the WebKit platform, Microsoft's Internet Explorer browser, Netscape's Navigator browser, Opera's browser, Mozilla's Firefox browser, or a WAP-enabled browser in the case of a cellular phone, PDA or other wireless device, or the like, allowing a user (for example, a subscriber of on-demand services provided by the system 816) of the user system 812 to access, process and view information, pages and applications available to it from the system 816 over the network 814.

Each user system 812 also typically includes one or more user input devices, such as a keyboard, a mouse, a trackball, a touch pad, a touch screen, a pen or stylus or the like, for interacting with a graphical user interface (GUI) provided by the browser on a display (for example, a monitor screen, liquid crystal display (LCD), light-emitting diode (LED) display, among other possibilities) of the user system 812 in conjunction with pages, forms, applications and other information provided by the system 816 or other systems or servers. For example, the user interface device can be used to access data and applications hosted by system 816, and to perform searches on stored data, and otherwise allow a user to interact with various GUI pages that may be presented to a user. As discussed above, implementations are suitable for use with the Internet, although other networks can be used instead of or in addition to the Internet, such as an intranet, an extranet, a virtual private network (VPN), a non-TCP/IP based network, any LAN or WAN or the like.

The users of user systems 812 may differ in their respective capacities, and the capacity of a particular user system 812 can be entirely determined by permissions (permission levels) for the current user of such user system. For example, where a salesperson is using a particular user system 812 to interact with the system 816, that user system can have the capacities allotted to the salesperson. However, while an administrator is using that user system 812 to interact with the system 816, that user system can have the capacities allotted to that administrator. Where a hierarchical role model is used, users at one permission level can have access to applications, data, and database information accessible by a lower permission level user, but may not have access to certain applications, database information, and data accessible by a user at a higher permission level. Thus, different users generally will have different capabilities with regard to accessing and modifying application and database information, depending on the users' respective security or permission levels (also referred to as “authorizations”).

According to some implementations, each user system 812 and some or all of its components are operator-configurable using applications, such as a browser, including computer code executed using a central processing unit (CPU) such as an Intel Pentium® processor or the like. Similarly, the system 816 (and additional instances of an MTS, where more than one is present) and all of its components can be operator-configurable using application(s) including computer code to run using the processor system 817, which may be implemented to include a CPU, which may include an Intel Pentium® processor or the like, or multiple CPUs.

The system 816 includes tangible computer-readable media having non-transitory instructions stored thereon/in that are executable by or used to program a server or other computing system (or collection of such servers or computing systems) to perform some of the implementation of processes described herein. For example, computer program code 826 can implement instructions for operating and configuring the system 816 to intercommunicate and to process web pages, applications and other data and media content as described herein. In some implementations, the computer code 826 can be downloadable and stored on a hard disk, but the entire program code, or portions thereof, also can be stored in any other volatile or non-volatile memory medium or device as is well known, such as a ROM or RAM, or provided on any media capable of storing program code, such as any type of rotating media including floppy disks, optical discs, digital versatile disks (DVD), compact disks (CD), microdrives, and magneto-optical disks, and magnetic or optical cards, nanosystems (including molecular memory ICs), or any other type of computer-readable medium or device suitable for storing instructions or data. Additionally, the entire program code, or portions thereof, may be transmitted and downloaded from a software source over a transmission medium, for example, over the Internet, or from another server, as is well known, or transmitted over any other existing network connection as is well known (for example, extranet, VPN, LAN, etc.) using any communication medium and protocols (for example, TCP/IP, HTTP, HTTPS, Ethernet, etc.) as are well known. It will also be appreciated that computer code for the disclosed implementations can be realized in any programming language that can be executed on a server or other computing system such as, for example, C, C++, HTML, any other markup language, Java™, JavaScript, ActiveX, any other scripting language, such as VBScript, and many other programming languages as are well known may be used. (Java™ is a trademark of Sun Microsystems, Inc.).

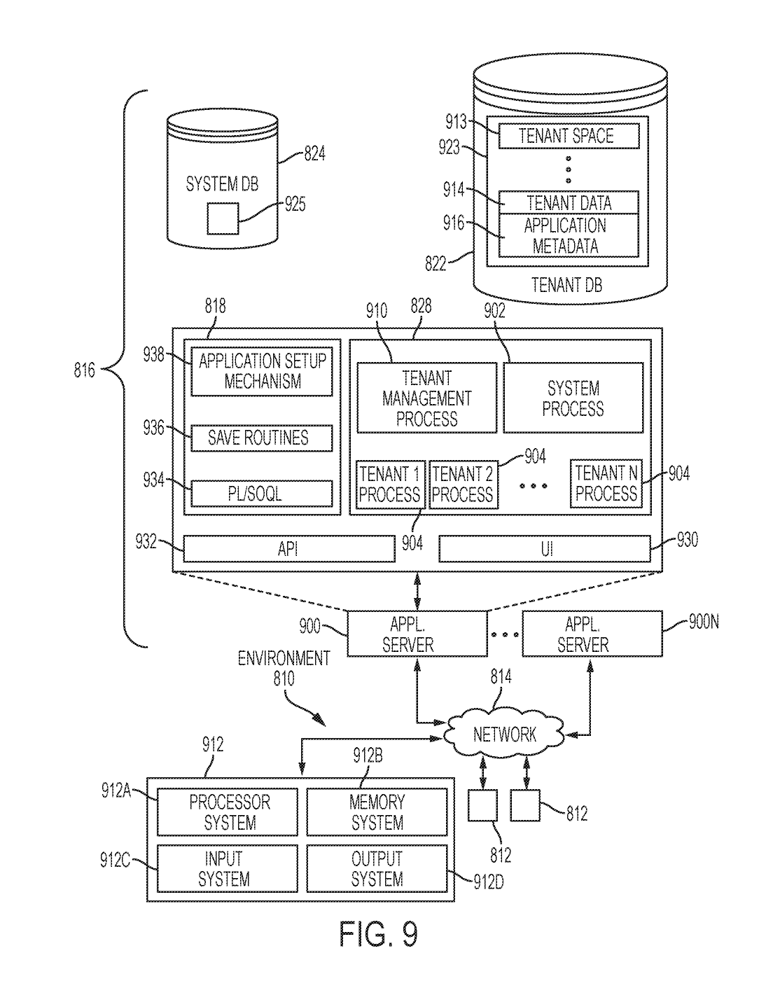

FIG. 9 shows a block diagram of example implementations of elements of FIG. 8 and example interconnections between these elements according to some implementations. That is, FIG. 9 also illustrates environment 810, but FIG. 9, various elements of the system 816 and various interconnections between such elements are shown with more specificity according to some more specific implementations. Elements from FIG. 8 that are also shown in FIG. 9 will use the same reference numbers in FIG. 9 as were used in FIG. 8. Additionally, in FIG. 9, the user system 812 includes a processor system 912A, a memory system 912B, an input system 912C, and an output system 912D. The processor system 912A can include any suitable combination of one or more processors. The memory system 912B can include any suitable combination of one or more memory devices. The input system 912C can include any suitable combination of input devices, such as one or more touchscreen interfaces, keyboards, mice, trackballs, scanners, cameras, or interfaces to networks. The output system 912D can include any suitable combination of output devices, such as one or more display devices, printers, or interfaces to networks.

In FIG. 9, the network interface 820 of FIG. 8 is implemented as a set of HTTP application servers 900₁-1400_{N}. Each application server 900, also referred to herein as an “app server,” is configured to communicate with tenant database 822 and the tenant data 923 therein, as well as system database 824 and the system data 925 therein, to serve requests received from the user systems 912. The tenant data 923 can be divided into individual tenant storage spaces 913, which can be physically or logically arranged or divided. Within each tenant storage space 913, tenant data 914 and application metadata 916 can similarly be allocated for each user. For example, a copy of a user's most recently used (MRU) items can be stored to user storage 914. Similarly, a copy of MRU items for an entire organization that is a tenant can be stored to tenant storage space 913.

The process space 828 includes system process space 902, individual tenant process spaces 904 and a tenant management process space 910. The application platform 818 includes an application setup mechanism 938 that supports application developers' creation and management of applications. Such applications and others can be saved as metadata into tenant database 822 by save routines 936 for execution by subscribers as one or more tenant process spaces 904 managed by tenant management process 910, for example. Invocations to such applications can be coded using PL/SOQL 934, which provides a programming language style interface extension to API 932. A detailed description of some PL/SOQL language implementations is discussed in commonly assigned U.S. Pat. No. 7,730,478, titled METHOD AND SYSTEM FOR ALLOWING ACCESS TO DEVELOPED APPLICATIONS VIA A MULTI-TENANT ON-DEMAND DATABASE SERVICE, by Craig Weissman, issued on Jun. 1, 2010, and hereby incorporated by reference in its entirety and for all purposes. Invocations to applications can be detected by one or more system processes, which manage retrieving application metadata 816 for the subscriber making the invocation and executing the metadata as an application in a virtual machine.

The system 816 of FIG. 9 also includes a user interface (UI) 930 and an application programming interface (API) 932 to system 816 resident processes to users or developers at user systems 912. In some other implementations, the environment 810 may not have the same elements as those listed above or may have other elements instead of, or in addition to, those listed above.

Each application server 900 can be communicably coupled with tenant database 822 and system database 824, for example, having access to tenant data 923 and system data 925, respectively, via a different network connection. For example, one application server 900₁ can be coupled via the network 814 (for example, the Internet), another application server 900_{N} can be coupled via a direct network link, and another application server (not illustrated) can be coupled by yet a different network connection. Transfer Control Protocol and Internet Protocol (TCP/IP) are examples of typical protocols that can be used for communicating between application servers 900 and the system 816. However, it will be apparent to one skilled in the art that other transport protocols can be used to optimize the system 816 depending on the network interconnections used.

In some implementations, each application server 900 is configured to handle requests for any user associated with any organization that is a tenant of the system 816. Because it can be desirable to be able to add and remove application servers 900 from the server pool at any time and for various reasons, in some implementations there is no server affinity for a user or organization to a specific application server 900. In some such implementations, an interface system implementing a load balancing function (for example, an F5 Big-IP load balancer) is communicably coupled between the application servers 900 and the user systems 912 to distribute requests to the application servers 900. In one implementation, the load balancer uses a least-connections algorithm to route user requests to the application servers 900. Other examples of load balancing algorithms, such as round robin and observed-response-time, also can be used. For example, in some instances, three consecutive requests from the same user could hit three different application servers 900, and three requests from different users could hit the same application server 900. In this manner, by way of example, system 816 can be a multi-tenant system in which system 816 handles storage of, and access to, different objects, data and applications across disparate users and organizations.

In one example storage use case, one tenant can be a company that employs a sales force where each salesperson uses system 816 to manage aspects of their sales. A user can maintain contact data, leads data, customer follow-up data, performance data, goals and progress data, etc., all applicable to that user's personal sales process (for example, in tenant database 822). In an example of a MTS arrangement, because all of the data and the applications to access, view, modify, report, transmit, calculate, etc., can be maintained and accessed by a user system 912 having little more than network access, the user can manage his or her sales efforts and cycles from any of many different user systems. For example, when a salesperson is visiting a customer and the customer has Internet access in their lobby, the salesperson can obtain critical updates regarding that customer while waiting for the customer to arrive in the lobby.

While each user's data can be stored separately from other users' data regardless of the employers of each user, some data can be organization-wide data shared or accessible by several users or all of the users for a given organization that is a tenant. Thus, there can be some data structures managed by system 816 that are allocated at the tenant level while other data structures can be managed at the user level. Because an MTS can support multiple tenants including possible competitors, the MTS can have security protocols that keep data, applications, and application use separate. Also, because many tenants may opt for access to an MTS rather than maintain their own system, redundancy, up-time, and backup are additional functions that can be implemented in the MTS. In addition to user-specific data and tenant-specific data, the system 816 also can maintain system level data usable by multiple tenants or other data. Such system level data can include industry reports, news, postings, and the like that are sharable among tenants.

In some implementations, the user systems 912 (which also can be client systems) communicate with the application servers 900 to request and update system-level and tenant-level data from the system 816. Such requests and updates can involve sending one or more queries to tenant database 822 or system database 824. The system 816 (for example, an application server 900 in the system 816) can automatically generate one or more SQL statements (for example, one or more SQL queries) designed to access the desired information. System database 824 can generate query plans to access the requested data from the database. The term “query plan” generally refers to one or more operations used to access information in a database system.

Each database can generally be viewed as a collection of objects, such as a set of logical tables, containing data fitted into predefined or customizable categories. A “table” is one representation of a data object, and may be used herein to simplify the conceptual description of objects and custom objects according to some implementations. It should be understood that “table” and “object” may be used interchangeably herein. Each table generally contains one or more data categories logically arranged as columns or fields in a viewable schema. Each row or element of a table can contain an instance of data for each category defined by the fields. For example, a CRM database can include a table that describes a customer with fields for basic contact information such as name, address, phone number, fax number, etc. Another table can describe a purchase order, including fields for information such as customer, product, sale price, date, etc. In some MTS implementations, standard entity tables can be provided for use by all tenants. For CRM database applications, such standard entities can include tables for case, account, contact, lead, and opportunity data objects, each containing pre-defined fields. As used herein, the term “entity” also may be used interchangeably with “object” and “table.”

In some MTS implementations, tenants are allowed to create and store custom objects, or may be allowed to customize standard entities or objects, for example by creating custom fields for standard objects, including custom index fields. Commonly assigned U.S. Pat. No. 7,779,039, titled CUSTOM ENTITIES AND FIELDS IN A MULTI-TENANT DATABASE SYSTEM, by Weissman et al., issued on Aug. 17, 2010, and hereby incorporated by reference in its entirety and for all purposes, teaches systems and methods for creating custom objects as well as customizing standard objects in a multi-tenant database system. In some implementations, for example, all custom entity data rows are stored in a single multi-tenant physical table, which may contain multiple logical tables per organization. It is transparent to customers that their multiple “tables” are in fact stored in one large table or that their data may be stored in the same table as the data of other customers.

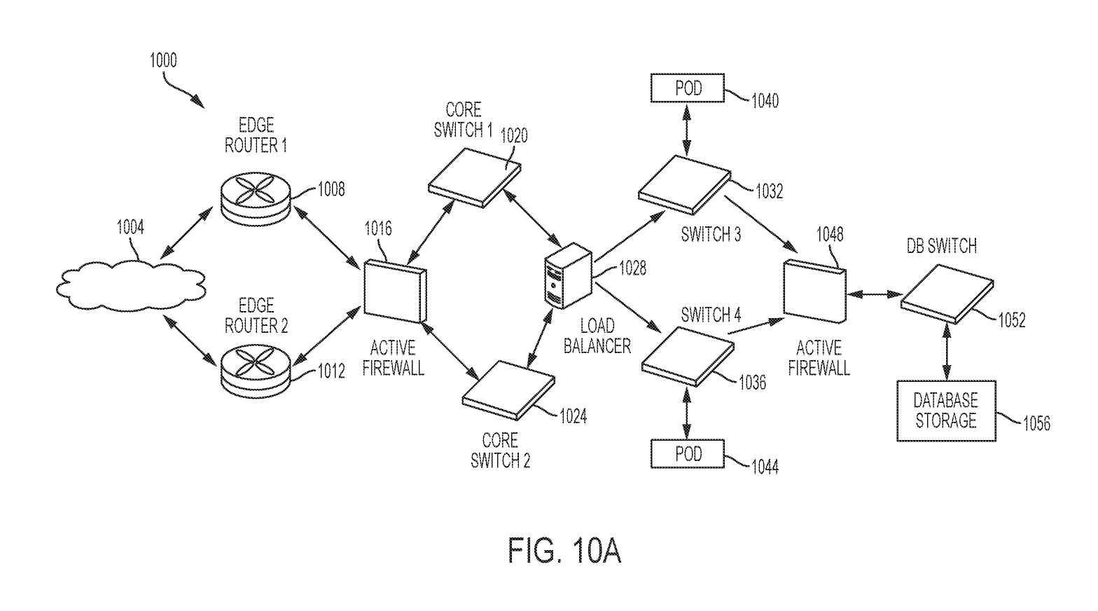

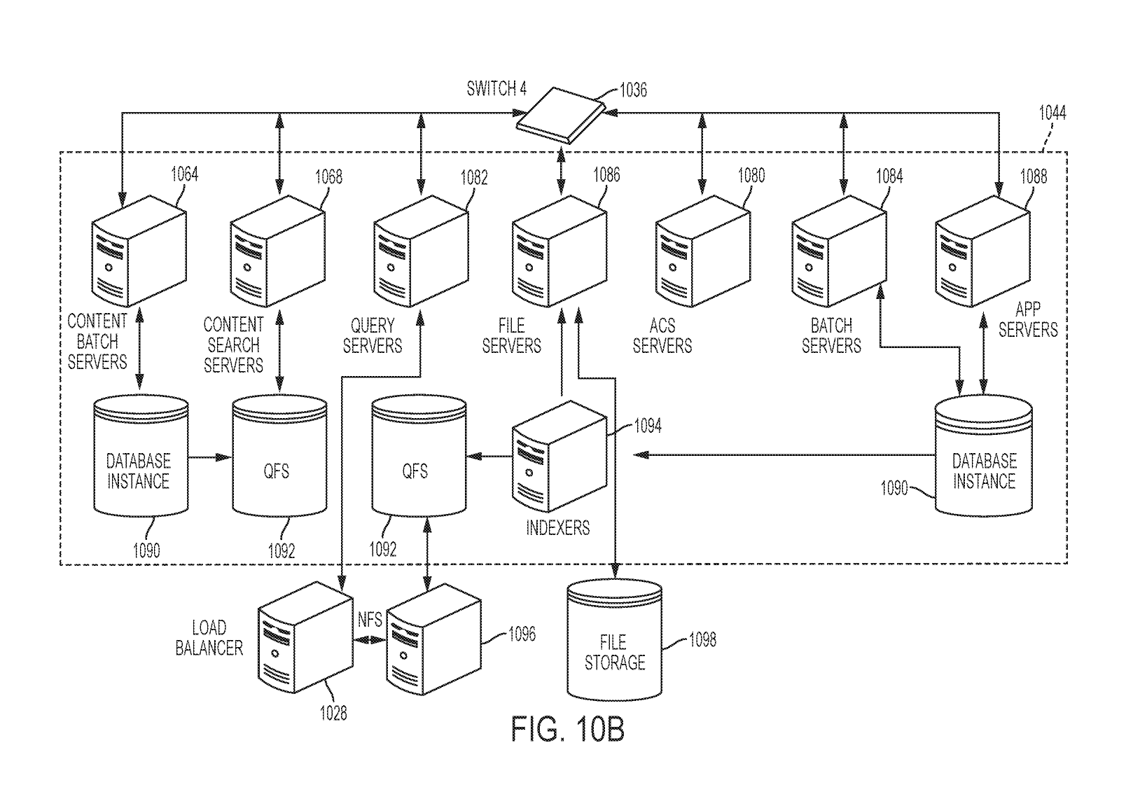

FIG. 10A shows a system diagram illustrating example architectural components of an on-demand database service environment 1000 according to some implementations. A client machine communicably connected with the cloud 1004, generally referring to one or more networks in combination, as described herein, can communicate with the on-demand database service environment 1000 via one or more edge routers 1008 and 1012. A client machine can be any of the examples of user systems 12 described above. The edge routers can communicate with one or more core switches 1020 and 1024 through a firewall 1016. The core switches can communicate with a load balancer 1028, which can distribute server load over different pods, such as the pods 1040 and 1044. The pods 1040 and 1044, which can each include one or more servers or other computing resources, can perform data processing and other operations used to provide on-demand services. Communication with the pods can be conducted via pod switches 1032 and 1036. Components of the on-demand database service environment can communicate with database storage 1056 through a database firewall 1048 and a database switch 1052.

As shown in FIGS. 10A and 10B, accessing an on-demand database service environment can involve communications transmitted among a variety of different hardware or software components. Further, the on-demand database service environment 1000 is a simplified representation of an actual on-demand database service environment. For example, while only one or two devices of each type are shown in FIGS. 10A and 10B, some implementations of an on-demand database service environment can include anywhere from one to several devices of each type. Also, the on-demand database service environment need not include each device shown in FIGS. 10A and 10B, or can include additional devices not shown in FIGS. 10A and 10B.

Additionally, it should be appreciated that one or more of the devices in the on-demand database service environment 1000 can be implemented on the same physical device or on different hardware. Some devices can be implemented using hardware or a combination of hardware and software. Thus, terms such as “data processing apparatus,” “machine,” “server” and “device” as used herein are not limited to a single hardware device, rather references to these terms can include any suitable combination of hardware and software configured to provide the described functionality.

The cloud 1004 is intended to refer to a data network or multiple data networks, often including the Internet. Client machines communicably connected with the cloud 1004 can communicate with other components of the on-demand database service environment 1000 to access services provided by the on-demand database service environment. For example, client machines can access the on-demand database service environment to retrieve, store, edit, or process information. In some implementations, the edge routers 1008 and 1012 route packets between the cloud 1004 and other components of the on-demand database service environment 1000. For example, the edge routers 1008 and 1012 can employ the Border Gateway Protocol (BGP). The BGP is the core routing protocol of the Internet. The edge routers 1008 and 1012 can maintain a table of IP networks or ‘prefixes’, which designate network reachability among autonomous systems on the Internet.

In some implementations, the firewall 1016 can protect the inner components of the on-demand database service environment 1000 from Internet traffic. The firewall 1016 can block, permit, or deny access to the inner components of the on-demand database service environment 1000 based upon a set of rules and other criteria. The firewall 1016 can act as one or more of a packet filter, an application gateway, a stateful filter, a proxy server, or any other type of firewall.

In some implementations, the core switches 1020 and 1024 are high-capacity switches that transfer packets within the on-demand database service environment 1000. The core switches 1020 and 1024 can be configured as network bridges that quickly route data between different components within the on-demand database service environment. In some implementations, the use of two or more core switches 1020 and 1024 can provide redundancy or reduced latency.

In some implementations, the pods 1040 and 1044 perform the core data processing and service functions provided by the on-demand database service environment. Each pod can include various types of hardware or software computing resources. An example of the pod architecture is discussed in greater detail with reference to FIG. 10B. In some implementations, communication between the pods 1040 and 1044 is conducted via the pod switches 1032 and 1036. The pod switches 1032 and 1036 can facilitate communication between the pods 1040 and 1044 and client machines communicably connected with the cloud 1004, for example via core switches 1020 and 1024. Also, the pod switches 1032 and 1036 may facilitate communication between the pods 1040 and 1044 and the database storage 1056. In some implementations, the load balancer 1028 can distribute workload between the pods 1040 and 1044. Balancing the on-demand service requests between the pods can assist in improving the use of resources, increasing throughput, reducing response times, or reducing overhead. The load balancer 1028 may include multilayer switches to analyze and forward traffic.

In some implementations, access to the database storage 1056 is guarded by a database firewall 1048. The database firewall 1048 can act as a computer application firewall operating at the database application layer of a protocol stack. The database firewall 1048 can protect the database storage 1056 from application attacks such as structure query language (SQL) injection, database rootkits, and unauthorized information disclosure. In some implementations, the database firewall 1048 includes a host using one or more forms of reverse proxy services to proxy traffic before passing it to a gateway router. The database firewall 1048 can inspect the contents of database traffic and block certain content or database requests. The database firewall 1048 can work on the SQL application level atop the TCP/IP stack, managing applications' connection to the database or SQL management interfaces as well as intercepting and enforcing packets traveling to or from a database network or application interface.

In some implementations, communication with the database storage 1056 is conducted via the database switch 1052. The multi-tenant database storage 1056 can include more than one hardware or software components for handling database queries. Accordingly, the database switch 1052 can direct database queries transmitted by other components of the on-demand database service environment (for example, the pods 1040 and 1044) to the correct components within the database storage 1056. In some implementations, the database storage 1056 is an on-demand database system shared by many different organizations as described above with reference to FIG. 8 and FIG. 9.

FIG. 10B shows a system diagram further illustrating example architectural components of an on-demand database service environment according to some implementations. The pod 1044 can be used to render services to a user of the on-demand database service environment 1000. In some implementations, each pod includes a variety of servers or other systems. The pod 1044 includes one or more content batch servers 1064, content search servers 1068, query servers 1082, file force servers 1086, access control system (ACS) servers 1080, batch servers 1084, and app servers 1088. The pod 1044 also can include database instances 1090, quick file systems (QFS) 1092, and indexers 1094. In some implementations, some or all communication between the servers in the pod 1044 can be transmitted via the switch 1036.

In some implementations, the app servers 1088 include a hardware or software framework dedicated to the execution of procedures (for example, programs, routines, scripts) for supporting the construction of applications provided by the on-demand database service environment 1000 via the pod 1044. In some implementations, the hardware or software framework of an app server 1088 is configured to execute operations of the services described herein, including performance of the blocks of various methods or processes described herein. In some alternative implementations, two or more app servers 1088 can be included and cooperate to perform such methods, or one or more other servers described herein can be configured to perform the disclosed methods.

The content batch servers 1064 can handle requests internal to the pod. Some such requests can be long-running or not tied to a particular customer. For example, the content batch servers 1064 can handle requests related to log mining, cleanup work, and maintenance tasks. The content search servers 1068 can provide query and indexer functions. For example, the functions provided by the content search servers 1068 can allow users to search through content stored in the on-demand database service environment. The file force servers 1086 can manage requests for information stored in the File force storage 1098. The File force storage 1098 can store information such as documents, images, and basic large objects (BLOBs). By managing requests for information using the file force servers 1086, the image footprint on the database can be reduced. The query servers 1082 can be used to retrieve information from one or more file storage systems. For example, the query system 1082 can receive requests for information from the app servers 1088 and transmit information queries to the NFS 1096 located outside the pod.

The pod 1044 can share a database instance 1090 configured as a multi-tenant environment in which different organizations share access to the same database. Additionally, services rendered by the pod 1044 may call upon various hardware or software resources. In some implementations, the ACS servers 1080 control access to data, hardware resources, or software resources. In some implementations, the batch servers 1084 process batch jobs, which are used to run tasks at specified times. For example, the batch servers 1084 can transmit instructions to other servers, such as the app servers 1088, to trigger the batch jobs.

In some implementations, the QFS 1092 is an open source file storage system available from Sun Microsystems® of Santa Clara, Calif. The QFS can serve as a rapid-access file storage system for storing and accessing information available within the pod 1044. The QFS 1092 can support some volume management capabilities, allowing many disks to be grouped together into a file storage system. File storage system metadata can be kept on a separate set of disks, which can be useful for streaming applications where long disk seeks cannot be tolerated. Thus, the QFS system can communicate with one or more content search servers 1068 or indexers 1094 to identify, retrieve, move, or update data stored in the network file storage systems 1096 or other storage systems.

In some implementations, one or more query servers 1082 communicate with the NFS 1096 to retrieve or update information stored outside of the pod 1044. The NFS 1096 can allow servers located in the pod 1044 to access information to access files over a network in a manner similar to how local storage is accessed. In some implementations, queries from the query servers 1082 are transmitted to the NFS 1096 via the load balancer 1028, which can distribute resource requests over various resources available in the on-demand database service environment. The NFS 1096 also can communicate with the QFS 1092 to update the information stored on the NFS 1096 or to provide information to the QFS 1092 for use by servers located within the pod 1044.

In some implementations, the pod includes one or more database instances 1090. The database instance 1090 can transmit information to the QFS 1092. When information is transmitted to the QFS, it can be available for use by servers within the pod 1044 without using an additional database call. In some implementations, database information is transmitted to the indexer 1094. Indexer 1094 can provide an index of information available in the database 1090 or QFS 1092. The index information can be provided to file force servers 1086 or the QFS 1092.

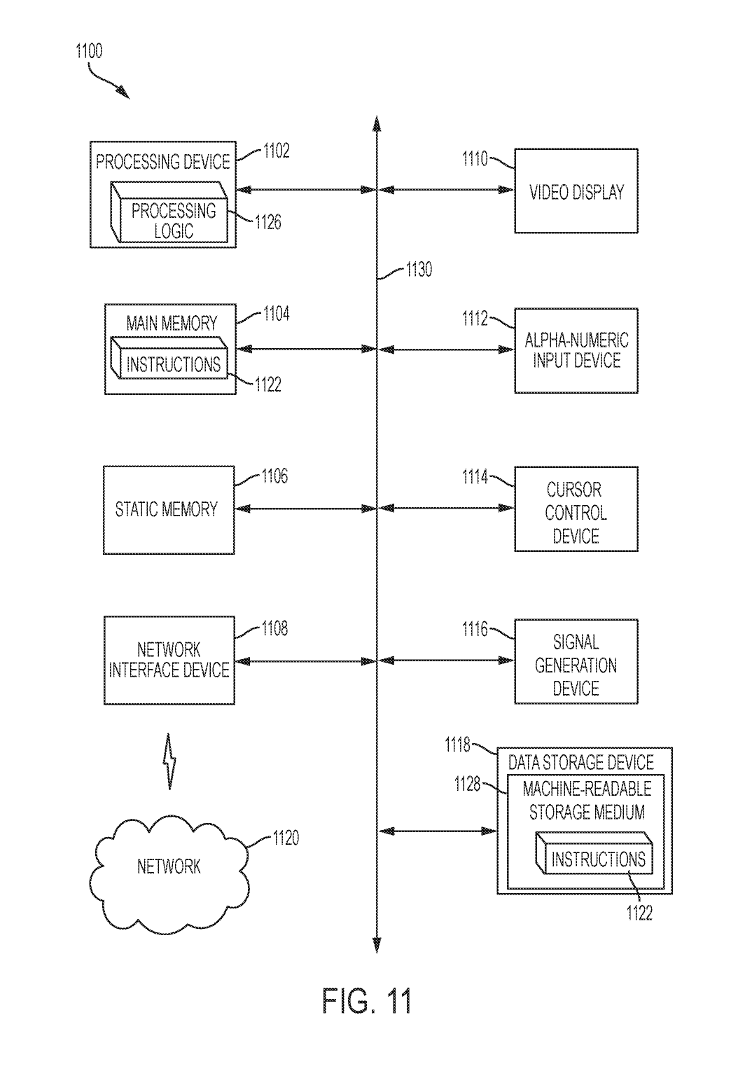

FIG. 11 illustrates a diagrammatic representation of a machine in the exemplary form of a computer system 1100 within which a set of instructions, for causing the machine to perform any one or more of the methodologies discussed herein, may be executed. The system 1100 may be in the form of a computer system within which a set of instructions, for causing the machine to perform any one or more of the methodologies discussed herein, may be executed. In alternative embodiments, the machine may be connected (e.g., networked) to other machines in a LAN, an intranet, an extranet, or the Internet. The machine may operate in the capacity of a server machine in client-server network environment. The machine may be a personal computer (PC), a set-top box (STB), a server, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The exemplary computer system 1100 includes a processing device (processor) 1102, a main memory 1104 (e.g., read-only memory (ROM), flash memory, dynamic random access memory (DRAM) such as synchronous DRAM (SDRAM)), a static memory 1106 (e.g., flash memory, static random access memory (SRAM)), and a data storage device 1118, which communicate with each other via a bus 1130.

Processing device 1102 represents one or more general-purpose processing devices such as a microprocessor, central processing unit, or the like. More particularly, the processing device 1102 may be a complex instruction set computing (CISC) microprocessor, reduced instruction set computing (RISC) microprocessor, very long instruction word (VLIW) microprocessor, or a processor implementing other instruction sets or processors implementing a combination of instruction sets. The processing device 1102 may also be one or more special-purpose processing devices such as an application specific integrated circuit (ASIC), a field programmable gate array (FPGA), a digital signal processor (DSP), network processor, or the like.

The computer system 1100 may further include a network interface device 1108. The computer system 1100 also may include a video display unit 1110 (e.g., a liquid crystal display (LCD) or a cathode ray tube (CRT)), an alphanumeric input device 1112 (e.g., a keyboard), a cursor control device 1114 (e.g., a mouse), and a signal generation device 1116 (e.g., a speaker).

The data storage device 1118 may include a computer-readable medium 1128 on which is stored one or more sets of instructions 1122 (e.g., instructions of in-memory buffer service 114) embodying any one or more of the methodologies or functions described herein. The instructions 1122 may also reside, completely or at least partially, within the main memory 1104 and/or within processing logic 1126 of the processing device 1102 during execution thereof by the computer system 1100, the main memory 1104 and the processing device 1102 also constituting computer-readable media. The instructions may further be transmitted or received over a network 1120 via the network interface device 1108.

While the computer-readable storage medium 1128 is shown in an exemplary embodiment to be a single medium, the term “computer-readable storage medium” should be taken to include a single medium or multiple media (e.g., a centralized or distributed database, and/or associated caches and servers) that store the one or more sets of instructions. The term “computer-readable storage medium” shall also be taken to include any medium that is capable of storing, encoding or carrying a set of instructions for execution by the machine and that cause the machine to perform any one or more of the methodologies of the present invention. The term “computer-readable storage medium” shall accordingly be taken to include, but not be limited to, solid-state memories, optical media, and magnetic media.

The preceding description sets forth numerous specific details such as examples of specific systems, components, methods, and so forth, in order to provide a good understanding of several embodiments of the present invention. It will be apparent to one skilled in the art, however, that at least some embodiments of the present invention may be practiced without these specific details. In other instances, well-known components or methods are not described in detail or are presented in simple block diagram format in order to avoid unnecessarily obscuring the present invention. Thus, the specific details set forth are merely exemplary. Particular implementations may vary from these exemplary details and still be contemplated to be within the scope of the present invention.

In the above description, numerous details are set forth. It will be apparent, however, to one of ordinary skill in the art having the benefit of this disclosure, that embodiments of the invention may be practiced without these specific details. In some instances, well-known structures and devices are shown in block diagram form, rather than in detail, in order to avoid obscuring the description.

Some portions of the detailed description are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as “determining”, “identifying”, “adding”, “selecting” or the like, refer to the actions and processes of a computer system, or similar electronic computing device, that manipulates and transforms data represented as physical (e.g., electronic) quantities within the computer system's registers and memories into other data similarly represented as physical quantities within the computer system memories or registers or other such information storage, transmission or display devices.

Embodiments of the invention also relate to an apparatus for performing the operations herein. This apparatus may be specially constructed for the required purposes, or it may comprise a general purpose computer selectively activated or reconfigured by a computer program stored in the computer. Such a computer program may be stored in a computer readable storage medium, such as, but not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions.

The algorithms and displays presented herein are not inherently related to any particular computer or other apparatus. Various general purpose systems may be used with programs in accordance with the teachings herein, or it may prove convenient to construct a more specialized apparatus to perform the required method steps. The required structure for a variety of these systems will appear from the description below. In addition, the present invention is not described with reference to any particular programming language. It will be appreciated that a variety of programming languages may be used to implement the teachings of the invention as described herein.

While at least one exemplary embodiment has been presented in the foregoing detailed description, it should be appreciated that a vast number of variations exist. It should also be appreciated that the exemplary embodiment or embodiments described herein are not intended to limit the scope, applicability, or configuration of the claimed subject matter in any way. Rather, the foregoing detailed description will provide those skilled in the art with a convenient road map for implementing the described embodiment or embodiments. It should be understood that various changes can be made in the function and arrangement of elements without departing from the scope defined by the claims, which includes known equivalents and foreseeable equivalents at the time of filing this patent application.

What is claimed is:

1. A method for deleting archive records of a tenant from a distributed archive database system after expiration, the method comprising:
defining, by the tenant, an archive retention policy for each object type, the archive retention policy comprising: a storage period that specifies how long changes to instances of objects of a particular object type are to be stored at a multi-tenant database system before being archived, and archive retention period that specifies how long archive records of the particular object type are to be archived before deleting them from the distributed archive database system;
running, at a deletion job scheduler, a deletion job for archive records of the tenant that have a particular object type;
dynamically determining, at the deletion job scheduler, a deletion window of archive records that are potentially eligible for deletion from the distributed archive database system;
calculating, at the deletion job scheduler, an oldest allowable archive timestamp value that is equal to a difference between a current date and time when the deletion job runs and the archive retention period for that tenant for that object type;
using index keys, at the deletion job scheduler, to query the distributed archive database system to retrieve archive records that are within the deletion window and belong to the tenant such that the archive records that belong to the tenant are ordered from oldest to newest based on their respective created dates;
identifying, at the deletion job scheduler, which of the archive records, that are within the deletion window and belong to the tenant, have expired; and
marking those expired records for deletion.

2. The method according to claim 1, wherein the deletion window includes only the archive records that have created dates that are in a range greater than or equal to a minimum lower boundary date (T1) and less than a maximum upper boundary date (T-END) so that only the archive records that are potentially eligible for deletion from the distributed archive database system are queried.

3. The method according to claim 1, further comprising:
defining page limits within the deletion window and dividing the deletion window into a set of limit bounded pages, wherein each limit bounded page includes a batch of archive records for a particular tenant of a particular object type; and
selecting a limit bounded page that includes archive records for the tenant from the set of limit bounded pages

4. The method according to claim 3, wherein identifying comprises:
evaluating, at the deletion job scheduler, each archive record within the limit bounded page to determine whether an archive timestamp value of that archive record is less than the oldest allowable archive timestamp value,
wherein the archive timestamp value for each archive record indicates a date and time when a change occurred to a corresponding instance of an object that reflects when that archive record should have been archived, and
wherein each archive record that has an archive timestamp value that is less than the oldest allowable archive timestamp value is marked as expired.

5. The method according to claim 4, wherein identifying further comprises:
determining, at the deletion job scheduler, for each archive record whether a created date is greater than or equal to a minimum lower boundary date (T1) of the limit bounded page; and
when the created date of the archive record is greater than or equal to the minimum lower boundary date (T1), determining, at the deletion job scheduler, whether the created date of that archive record is less than an upper boundary date (T2) of the limit bounded page; and
where the evaluating is performed when the deletion job scheduler determines that the created date of that archive record is less than the upper boundary date (T2) of the limit bounded page.

6. The method according to claim 4, wherein the oldest allowable archive timestamp value defines a point in time where any archive record that has an archive timestamp less than the oldest allowable archive timestamp value will be considered to be expired and ready for deletion.

7. The method according to claim 1, further comprising:
chunking the expired records that are to be deleted into groups at the deletion job scheduler; and
enqueuing the groups of expired records in a message queue for deletion;
dequeuing the groups of expired records at the message queue; and
deleting the groups of expired records.

8. The method according to claim 1, wherein each index key is arranged according to a query pattern that includes a tenant identifier (TENANT_ID) field that specifies the tenant, a parent key prefix (PARENT_KEY_PREFIX) field that specifies the object type, a created date (CREATED_DATE) field that indicates the date and time on which an instance of an object was modified and the archive record was created, a parent identifier (PARENT_ID) that specifies an identifier for the actual instance of an object that was changed, and an entity history identifier (ENTITY_HISTORY_ID) that uniquely identifies a specific change.

9. The method according to claim 8, wherein the query pattern of each index key is arranged to find the oldest archive records in the deletion window sorted by created date in descending order down to the newest archive records in the deletion window so that archive records that are more likely to be expired are found first.

10. A multi-tenant archive system, comprising:
a multi-tenant database system that is configured to store changes to instances of objects for a plurality of tenants for a tenant-defined storage period specified by each tenant, wherein each tenant-defined storage period specifies, for each object type of a plurality of different object types, how long changes to instances of objects of that particular object type are to be stored before being archived;
a distributed archive database system that is configured to archive the changes to the instances of objects for the plurality of tenants as archive records, wherein the changes to the instances of objects for each tenant are archived when the tenant-defined storage period for that object type expires until a tenant-defined archive retention period specified by each tenant for that object type expires, wherein each tenant-defined archive retention period specifies, for each object type, how long archive records of that particular object type are to be archived before being deleted from the distributed archive database system; and
a deletion job processor configured to run a deletion job for archive records of a tenant that have a particular object type to:
dynamically determine a deletion window of archive records that are potentially eligible for deletion from the distributed archive database system;
calculate an oldest allowable archive timestamp value that is equal to a difference between a current date and time when the deletion job runs and the tenant-defined archive retention period for that tenant for that object type;
query the distributed archive database system using index keys to retrieve archive records that are within the deletion window and belong to the tenant such that the archive records that belong to the tenant are ordered from oldest to newest based on their respective created dates;
identify which of the archive records, that are within the deletion window and belong to the tenant, have expired; and
mark those expired records for deletion.

11. The multi-tenant archive system according to claim 10, wherein the deletion window includes only the archive records have created dates that are in a range greater than or equal to a minimum lower boundary date (T1) and less than a maximum upper boundary date (T-END) so that only the archive records that are potentially eligible for deletion from the distributed archive database system are queried.

12. The multi-tenant archive system according to claim 10, wherein the deletion job processor is further configured to:
define page limits within the deletion window and dividing the deletion window into a set of limit bounded pages, wherein each limit bounded page includes a batch of archive records for a particular tenant of a particular object type; and
select a limit bounded page that includes archive records for the tenant from the set of limit bounded pages

13. The multi-tenant archive system according to claim 12, wherein the deletion job processor is further configured to:
evaluate each archive record within the limit bounded page to determine whether an archive timestamp value of that archive record is less than the oldest allowable archive timestamp value,
wherein the archive timestamp value for each archive record indicates a date and time when a change occurred to a corresponding instance of an object that reflects when that archive record should have been archived, and
wherein each archive record that has an archive timestamp value that is less than the oldest allowable archive timestamp value is marked as expired.

14. The multi-tenant archive system according to claim 13, wherein the deletion job processor is further configured to:
determine for each archive record whether a created date of that archive record is greater than or equal to a minimum lower boundary date (T1) of the limit bounded page; and
determine, when the created date of an archive record is greater than or equal to the minimum lower boundary date (T1), whether the created date of that archive record is less than an upper boundary date (T2) of the limit bounded page; and
wherein the deletion job processor is further configured to evaluate when the created date of that archive record is less than the upper boundary date (T2) of the limit bounded page.

15. The multi-tenant archive system according to claim 13, wherein the oldest allowable archive timestamp value defines a point in time where any archive record that has an archive timestamp less than the oldest allowable archive timestamp value will be considered to be expired and ready for deletion.

16. The multi-tenant archive system according to claim 10, further comprising:
a message queue, wherein the deletion job processor is further configured to: chunk the expired records that are to be deleted into groups, and enqueue the groups of expired records in the message queue for deletion, and
wherein the message queue is configured to dequeue and delete the groups of expired records.

17. The multi-tenant archive system according to claim 10, wherein each index key is arranged according to a query pattern that includes a tenant identifier (TENANT_ID) field that specifies the tenant, a parent key prefix (PARENT_KEY_PREFIX) field that specifies the object type, a created date (CREATED_DATE) field that indicates the date and time on which an instance of an object was modified and the archive record was created, a parent identifier (PARENT_ID) that specifies an identifier for the actual instance of an object that was changed, and an entity history identifier (ENTITY_HISTORY_ID) that uniquely identifies a specific change.

18. The multi-tenant archive system according to claim 17, wherein the query pattern of each index key is arranged to find the oldest archive records in the deletion window sorted by created date in descending order down to the newest archive records in the deletion window so that archive records that are more likely to be expired are found first.

19. A computer-implemented deletion job scheduler, comprising:
a processor; and
a memory, wherein the memory comprises computer-executable instructions that are capable of causing the processor to run a deletion job for archive records of a tenant that have a particular object type to:
dynamically determine a deletion window of archive records that are potentially eligible for deletion from a distributed archive database system that is configured to archive changes to instances of objects for a plurality of tenants as archive records, wherein the changes to the instances of the objects for each tenant are archived until a tenant-defined archive retention period specified by each tenant for that object type expires;
calculate an oldest allowable archive timestamp value that is equal to a difference between a current date and time when the deletion job runs and the tenant-defined archive retention period for that tenant for that object type;
query the distributed archive database system using index keys to retrieve archive records that are within the deletion window and belong to the tenant such that the archive records that belong to the tenant are ordered from oldest to newest based on their respective created dates;
identify which of the archive records, that are within the deletion window and belong to the tenant, have expired; and
mark those expired records for deletion.

20. The computer-implemented deletion job scheduler of claim 19, wherein each index key is arranged according to a query pattern that includes a tenant identifier (TENANT_ID) field that specifies the tenant, a parent key prefix (PARENT_KEY_PREFIX) field that specifies the object type, a created date (CREATED_DATE) field that indicates the date and time on which an instance of an object was modified and the archive record was created, a parent identifier (PARENT_ID) that specifies an identifier for the actual instance of an object that was changed, and an entity history identifier (ENTITY_HISTORY_ID) that uniquely identifies a specific change,
wherein the query pattern of each index key is arranged to find the oldest archive records in the deletion window sorted by created date in descending order down to the newest archive records in the deletion window so that archive records that are more likely to be expired are found first.
